(19) United States
(12) Patent Application Publication
(10) Pub. No.: US 2026/0017332 A1
(43) Pub. Date: Jan. 15, 2026

(54) INFORMATION SEARCH METHOD AND APPARATUS, ELECTRONIC DEVICE, AND STORAGE MEDIUM

(71) Applicant: Tencent Technology (Shenzhen) Company Limited, Shenzhen (CN)

(72) Inventor: Jianjun CHEN, Shenzhen (CN)

(73) Assignee: Tencent Technology (Shenzhen) Company Limited, Shenzhen (CN)

(21) Appl. No.: 19/335,247

(22) Filed: Sep. 22, 2025

Related U.S. Application Data
(63) Continuation of application No. PCT/CN2024/107183, filed on Jul. 24, 2024.

(30) Foreign Application Priority Data
Sep. 8, 2023 (CN) 202311162653.5

(51) Int. Cl. G06F 16/9538; G06F 16/9535

(52) U.S. Cl. CPC G06F 16/9538; G06F 16/9535

(57) ABSTRACT

An information search method, apparatus, and computer-readable storage medium for providing intelligent search recommendations based on content marking behavior. The method displays a content detail interface and receives marking operations selecting content segments within target content. Marking identifiers are displayed for the selected segments. Based on segment detail information from current and previous marking operations, recommended search information is generated and displayed. Users can select target recommended search information through search operations, and corresponding search results are displayed. This approach enables personalized search suggestions derived from user marking patterns and content interaction history, improving search relevance and user experience.

### CROSS-REFERENCE TO RELATED APPLICATIONS

This application is a continuation application of International Application No. PCT/CN2024/107183 filed on Jul. 24, 2024 which claims priority to Chinese Patent Application No. 202311162653.5, filed with the China National Intellectual Property Administration on Sep. 8, 2023, the disclosures of each being incorporated by reference herein in their entireties.

### FIELD

The disclosure relates to the technical field of the Internet, and information search technology.

### BACKGROUND

In the related art, with the popularization of computers and the development of the Internet, people's use of networks has become increasingly frequent. Computers and networks have gradually become indispensable tools in people's daily lives. Network search services are widely applied to people's daily lives because they can provide various information and data for objects, bringing great convenience to people.

For instance, in a current browser search environment, an object may need to manually input a search keyword, and a browser search engine mainly relies on the search keyword inputted by the object to provide a search result.

The object may need to spend time thinking and inputting a search keyword. This may lead to information delay when the object may acquire information quickly. In addition, since the selection and input manner of the search keyword may affect the accuracy of the search result, the object may may attempt to input different search keywords multiple times and conduct multiple searches to find information satisfying the requirements. It may be learned that the information search manner in the related art excessively relies on the search keyword inputted by the object, resulting in relatively low search efficiency.

In summary, how to improve the information search efficiency is an urgent problem to be solved.

### SUMMARY

Provided are an information search method and apparatus, a device, a storage medium, and a program product, which can implement intelligent search recommendations based on user marking behavior and historical marking patterns within content.

According to some embodiments, an information search method, performed by an electronic device, includes: displaying a content detail interface of target content; receiving a marking operation selecting at least one content segment within the target content; displaying, based on the marking operation, marking identifiers corresponding to the at least one content segment; generating and displaying at least one piece of recommended search information based on segment detail information in content segments marked by the marking operation and at least one previous marking operation; and receiving a search operation selecting target recommended search information from the at least one piece of recommended search information; displaying a search result corresponding to the target recommended search information.

According to some embodiments, an information search apparatus, includes: at least one memory configured to store program code; and at least one processor configured to read the program code and operate as instructed by the program code, the program code including: display code configured to cause at least one of the at least one processor to display a content detail interface of target content; receiving code configured to cause at least one of the at least one processor to receive a marking operation selecting at least one content segment within the target content; marking code configured to cause at least one of the at least one processor to display, based on the marking operation, marking identifiers corresponding to the at least one content segment; recommendation code configured to cause at least one of the at least one processor to generate and display at least one piece of recommended search information based on segment detail information in content segments marked by the marking operation and at least one previous marking operation; and search code configured to cause at least one of the at least one processor to receive a search operation selecting target recommended search information from the at least one piece of recommended search information; result code configured to cause at least one of the at least one processor to display a search result corresponding to the target recommended search information.

According to some embodiments, a non-transitory computer-readable storage medium, storing computer code which, when executed by at least one processor, causes the at least one processor to at least: display a content detail interface of target content; receive a marking operation selecting at least one content segment within the target content; display, based on the marking operation, marking identifiers corresponding to the at least one content segment; generate and display at least one piece of recommended search information based on segment detail information in content segments marked by the marking operation and at least one previous marking operation; and receive a search operation selecting target recommended search information from the at least one piece of recommended search information; display a search result corresponding to the target recommended search information.

### BRIEF DESCRIPTION OF THE DRAWINGS

The accompanying drawings described herein are intended to provide a further understanding of this application, and form a part of this application. Exemplary embodiments of this application and descriptions thereof are used for explaining this application, and do not constitute any inappropriate limitation to this application. In the drawings:

FIG. 1 is a schematic diagram of an application scene according to some embodiments.

FIG. 2 is an implementation flowchart of an information search method according to some embodiments.

FIG. 3 is a schematic diagram of a content detail interface according to some embodiments.

FIG. 4 is a schematic diagram of another content detail interface according to some embodiments.

FIG. 5 is a schematic diagram of a first process of marking a content segment according to some embodiments.

FIG. 6 is a schematic diagram of a second process of marking a content segment according to some embodiments.

FIG. 7 is a schematic diagram of a third process of marking a content segment according to some embodiments.

FIG. 8 is a schematic diagram of recommended search information according to some embodiments.

FIG. 9 is a schematic diagram of another process of marking a content segment according to some embodiments.

FIG. 10 is a schematic diagram of a process of information search based on target recommended search information according to some embodiments.

FIG. 11 is a schematic diagram of a first search information set according to some embodiments.

FIG. 12 is a schematic diagram of another first search information set according to some embodiments.

FIG. 13 is a schematic diagram of a process of information search based on target first search information according to some embodiments.

FIG. 14 is a schematic diagram of second search information according to some embodiments.

FIG. 15 is a schematic diagram of a process of autonomous splicing search based on second search information according to some embodiments.

FIG. 16 is a schematic diagram of third search information according to some embodiments.

FIG. 17 is a schematic diagram of another third search information according to some embodiments.

FIG. 18 is a schematic diagram of yet another third search information according to some embodiments.

FIG. 19 is a schematic diagram of presenting a search result based on third search information according to some embodiments.

FIG. 20 is a schematic diagram of another content detail interface according to some embodiments.

FIG. 21 is a schematic diagram of a switch control according to some embodiments.

FIG. 22 is an implementation flowchart of an information search method according to some embodiments.

FIG. 23 is a schematic diagram of generation logic of recommended search information according to some embodiments.

FIG. 24 is a schematic structural diagram of an information search apparatus according to some embodiments.

FIG. 25 is a schematic structural diagram of another information search apparatus according to some embodiments.

FIG. 26 is a schematic structural diagram of hardware of an electronic device according to some embodiments.

FIG. 27 is a schematic structural diagram of hardware of another electronic device according to some embodiments.

### DESCRIPTION OF EMBODIMENTS

To make the objectives, technical solutions, and advantages of embodiments of this application clearer, the technical solutions of this application will be clearly and completely described below in conjunction with the accompanying drawings in some embodiments. Apparently, the described embodiments are merely some embodiments of the technical solutions of this application rather than all of the embodiments. All other embodiments obtained by a person skilled in the art based on the embodiments recorded in this application without involving inventive effort shall fall within the protection scope of the technical solutions of this application.

Marking identifier: in this disclosure, when browsing content details of target content, an object may directly mark content segments in a content detail interface in real time. For example, the object may mark, according to its own requirement, an interested content segment, a doubtful content segment, or the like. The marking identifier refers to an identifier that is presented in the content detail interface when the object marks a content segment, indicating that the content segment is marked. The identifier corresponds to the content segment. For example, the marking identifier may include at least one of the following: a selection mark configured for identifying a selected content segment, and a marking sequence number.

Recommended search information: it refers to search information generated based on content detail information contained in the content segment marked by the object and is used as basic information for subsequent searches. It may be a search keyword, a search sentence, or the like. The object may select the recommended search information to perform an intelligent search and view a corresponding search result.

Switch control: it is a control configured to enable or disable an intelligent marking search function. The intelligent marking search function is a function of generating recommended search information based on the content segment marked by the object, and further performing an intelligent search based on the recommended search information. After the control is enabled, the content detail interface may support the object to mark a content segment, and intelligently generate the recommended search information according to the content segment marked by the object. Specifically, after the control is enabled, a search sub-interface may be presented in the content detail interface, and the object may perform marking in the content detail interface. After the object completes at least one mark, corresponding recommended search information is presented in the search sub-interface. After the control is disabled, display of the search sub-interface may be canceled in the content detail interface, and all marking information of the object is cleared.

First search information set: in this application, it refers to a set including intelligent search information (which may be briefly referred to as an intelligent search information set). Content segments marked by the object in the target content each correspond to a first search information set, and each first search information set includes at least one piece of first search information. The first search information is intelligently generated according to the content segments marked by the object. Specifically, each time the object marks a content segment, a corresponding first search information set may be generated. First search information in the first search information set includes: at least one piece of recommended search information generated based on the content segments marked by the object currently and previously and candidate search information.

Second search information: in this application, it refers to search information that may be autonomously spliced by the object. The search information is also intelligently generated according to the content segment marked by the object. However, the second search information is different from the first search information. The second search information is recommended search information generated based on the content segment marked by the object currently.

Third search information: in this application, it refers to reverse search information corresponding to the first search information. Specifically, the third search information and the first search information, which are reverse search information to each other, have search results whose contents are semantically opposite.

In some embodiments, semantic analysis may be performed on content detail information contained in marking information based on the natural language processing (NLP) technology and the machine learning technology to generate corresponding recommended search information, first search information, second search information, third search information, and the like, so that the object can perform an intelligent search based on the automatically generated search information, thereby improving the information search efficiency.

In addition, the information search method in some embodiments further relates to database technology. For example, in some embodiments, when authenticity verification is performed on the search result corresponding to the recommended search information, an authoritative database may be queried. For another example, in some embodiments, various types of generated recommended search information may further be stored in a database for subsequent use.

A design idea of some embodiments is briefly described below.

In the current network search service, a search manner supported by almost all search engines is that the object inputs a search keyword, and a search engine returns a result related to the search keyword. The search engine understands the query input of the object using the NLP technology to help the search engine better understand requirements of the object, and ranks search results according to various factors (such as the authority of a page, the correlation of content, and the search history of the object) to form a correlation sequence. In this manner, the search engine provides the search result mainly relying on the search keyword inputted by the object, and the object may spend time thinking and inputting the search keyword. In addition, since the selection and input manner of the search keyword may affect the accuracy of the search result, the object may may attempt to input different search keywords multiple times and conduct multiple searches to find information satisfying the requirements, resulting in relatively low search efficiency.

In addition, if the objects encounter a plurality of pieces of interested content when browsing a web page or reading a document, they may may remember the content, and then perform searching separately later, which is neither convenient nor efficient.

Meanwhile, in this case, the objects may generate new requirements. For example, they may hope to directly mark interested texts when browsing content, and automatically save these texts as search requests (queries, i.e., recommended search information) to perform searching when needed. They may further hope to search for a plurality of queries simultaneously to acquire more related information at once.

In the related art, to improve the search efficiency of the object, some search engines may combine a recommendation system and an object modeling technology to provide personalized search results according to the search history and behavior data of the object. Such a search engine generates a keyword recommendation model by analyzing a search behavior of the object to satisfy the search requirement of the object more accurately, shorten the search time, and reduce the search cost. Recording is performed mainly depending on two types of search behaviors: the first type is a search performed by the object after browsing content, recording the browsed content and searched keywords; the second type is a search order of keywords that the object continuously searches for. According to these records, a system generates two association relationships: the first is an association relationship between the content and the search keyword, and the second is an association relationship between the search keywords. However, in this manner, after browsing the content, the object still may leave the current browsing page for searching, and after analyzing the browsed content, may manually input the keyword.

In view of this, some embodiments provide an information search method and apparatus, an electronic device, and a storage medium. In some embodiments, when browsing content details of the target content, the object may directly mark the content segments in the content detail interface. For example, the object may mark, according to its own requirement, an interested content segment, a doubtful content segment, or the like. Further, in this application, according to the marking operation of the object in a browsing process, the recommended search information may be intelligently generated based on the segment detail information contained in the content segments marked by the object currently and previously, and presented to the object. Since the recommended search information is generated through analysis according to the content segments marked by the object, a search requirement of the object may be effectively reflected. In addition, based on this, the object may further perform an information search based on the target recommended search information in the displayed recommended search information. In the search process, the object marks the content segments only according to its own search requirement and does not may spend time thinking and manually inputting a search keyword, thereby effectively improving the search efficiency. In addition, based on better satisfying the search requirement of the object, this manner may further help the object to discover and acquire more related information, thereby improving the search experience of the object and improving the richness of information acquired by the object.

Preferred embodiments of this application are described below with reference to the accompanying drawings. The preferred embodiments described herein are merely used for illustrating and explaining this application and are not intended to limit this application. In addition, the embodiments and features of the embodiments in this application may be combined with each other without conflict.

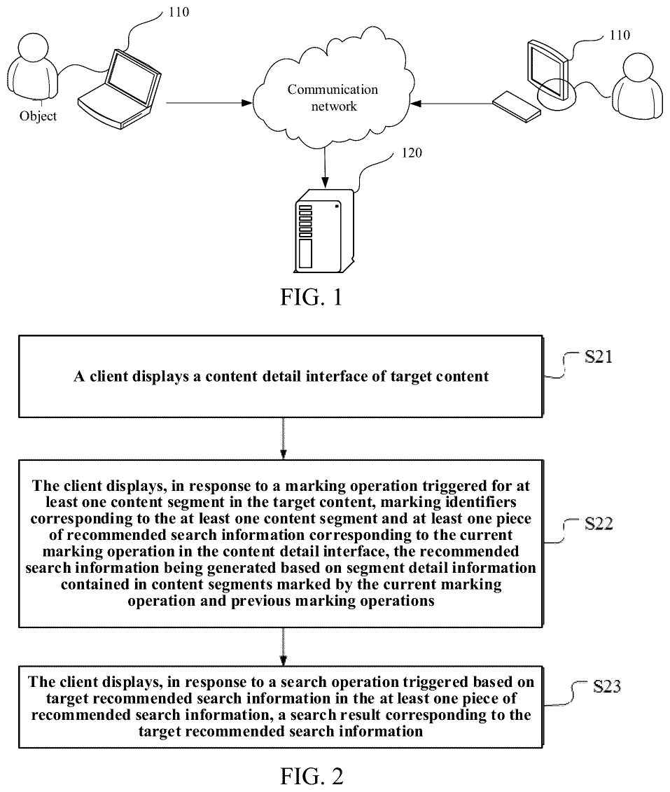

FIG. 1 is a schematic diagram of an application scene according to some embodiments. The diagram of the application scene includes two terminal devices 110 and one server 120.

In some embodiments, the terminal device 110 includes, but is not limited to, devices such as a mobile phone, a tablet computer, a notebook computer, a desktop computer, an e-book reader, an intelligent voice interaction device, a smart home appliance, and an in-vehicle terminal. An information search-related client may be installed on the terminal device 110. The client may be software (such as a browser or media software), or a web page, a mini program, or the like. The server 120 is a backend server corresponding to the software, web page, mini program, or the like, or a server configured for information search. The server 120 may be an independent physical server, may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform.

The information search method in some embodiments may be performed by an electronic device, and the electronic device may be the terminal device 110 or the server 120. That is, the method may be performed by the terminal device 110 or the server 120 alone, or may be jointly performed by the terminal device 110 and the server 120. For example, when the method is jointly performed by the terminal device 110 and the server 120, a client (for example, a browser) related to an information search service is deployed on the terminal device 110. When the client receives a marking operation triggered by the object for target content in a content detail interface of the target content, the terminal device 110 may transmit a corresponding marked segment to the server 120. Then, the server 120 performs semantic analysis on content detail information contained in the marked segment to generate at least one piece of recommended search information, and then transmits the at least one piece of recommended search information to the terminal device 110. The terminal device 110 presents the at least one piece of recommended search information in the content detail interface of the target content through the client. In addition, when the object selects target recommended search information in the at least one piece of recommended search information, the client transmits, in response to a search operation triggered based on the target recommended search information, a search request generated based on the target recommended search information to the server 120 through the terminal device 110. The server 120 acquires search results corresponding to the target recommended search information and feeds back the search results to the terminal device 110. The terminal device 110 presents these search results through the client.

In an implementation, the terminal device 110 may communicate with the server 120 through a communication network. In an implementation, the communication network may be a wired network or a wireless network.

FIG. 1 is merely an example for description. Actually, the number of terminal devices and servers is not limited and is not defined in some embodiments.

In some embodiments, when there are a plurality of servers, the plurality of servers may form a blockchain, and the servers are nodes on the blockchain. For example, the target content and related search information involved in the information search method disclosed in some embodiments may be stored on the blockchain, for example, the target content, content segments marked in the target content, the first search information, the second search information, and the third search information.

In addition, some embodiments may be applied to various scenes, including but not limited to, cloud technology, artificial intelligence, intelligent transportation, and assisted driving.

In a implementation of this application, related data such as the target content, marking behaviors of the object (such as the object), and marked content segments is involved. When some embodiments are applied to a product or technology, permission or consent of the object may be obtained, and acquisition, use, and processing of the related data may comply with relevant laws, regulations, and standards of relevant countries and regions.

The information search method provided in some embodiments is described below with reference to the foregoing described application scene and the accompanying drawings. The foregoing application scene is merely shown for ease of understanding the spirit and principle, and some embodiments are not limited in this aspect.

FIG. 2 is an implementation flowchart of an information search method according to some embodiments. Using a client (for example, a browser) installed in an electronic device being an execution subject as an example, a implementation procedure of the method is shown as the following S21 to S23.

S21: The client displays a content detail interface of target content.

In some embodiments, the target content refers to electronic content currently viewed by the object, which may be, for example, an article (for example, movie comment articles or entertainment news) or news information, and may include information such as texts or pictures.

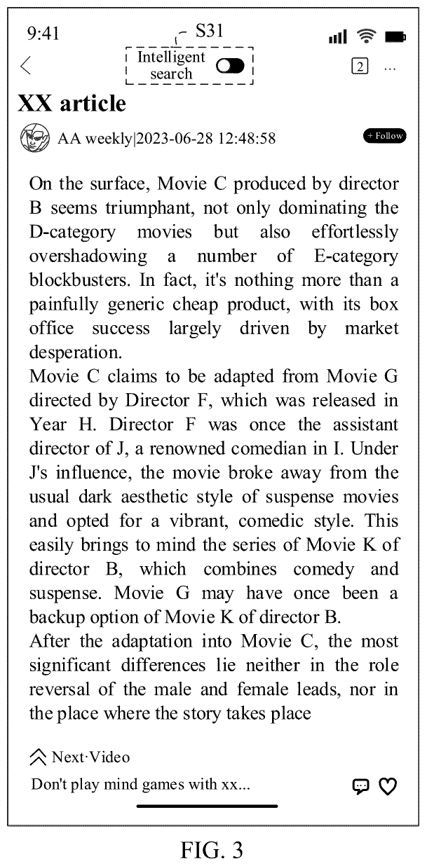

The content detail interface of the target content is an object-oriented interface configured for presenting content details corresponding to the target content to the object, for example, presenting content details such as texts or pictures contained in the target content. FIG. 3 is a schematic diagram of a content detail interface according to some embodiments. The target content shown in FIG. 3 is a movie comment article, which describes comments of a publishing object of the article on a movie C produced by a director B.

In some embodiments, a convenient and clear content marking function is provided for the object so that when browsing the target content and sliding downwards, the object can freely mark an interested content segment.

Based on this function, the object may mark the content segment in real time in the content detail interface of the target content, and further related recommended search information is intelligently generated based on the mark of the object. This function may be briefly referred to as an intelligent marking search function in some embodiments.

Using the target content being text content as an example, the object may mark an interested or doubtful character, word, sentence, paragraph, or the like in the content detail interface, and each marked character, word, sentence, paragraph, or the like may be recorded as a content segment. After the object marks the content segment, for the marked content segment, corresponding recommended search information may be displayed on the content detail interface.

Certainly, in addition to the text content, the target content may further contain other content such as pictures. For example, when the marked content segment contains a picture, the picture may be first parsed, and then related recommended search information is generated according to a parsing result; or texts in the picture may be extracted to directly generate related recommended search information.

The information search method in some embodiments is described below using an example in which the target content contains the text content.

In some embodiments, the foregoing intelligent marking search function may be enabled by default. That is, in a content detail interface of any piece of content, the object may directly perform marking, and recommended search information is intelligently generated according to the mark. In some embodiments, the object sets the intelligent marking search function to be enabled or disabled in the client. In this case, enabling or disabling of the intelligent marking search function is performed for all content detail interfaces in the client by default. For example, a corresponding controlling control is configured in a setting bar of a browser, and the object may select to enable or disable the intelligent marking search function for all content detail interfaces based on the controlling control.

In some embodiments, enabling or disabling of the intelligent marking search function may be controlled by a switch and is independently controlled for a single content detail interface. For example, a switch control configured to control to enable or disable the intelligent marking search function is provided in the content detail interface. Based on the switch control, the object may control to enable or disable the intelligent marking search function for a content detail interface corresponding to a piece of content.

Still using FIG. 3 as an example, S31 in FIG. 3 is an example of a switch control in some embodiments. When the object enters the content detail interface, there is an intelligent marking search switch in the content detail interface, and the switch control shown in S31 is currently in an off state. The object may adjust the state of the switch control by clicking or the like.

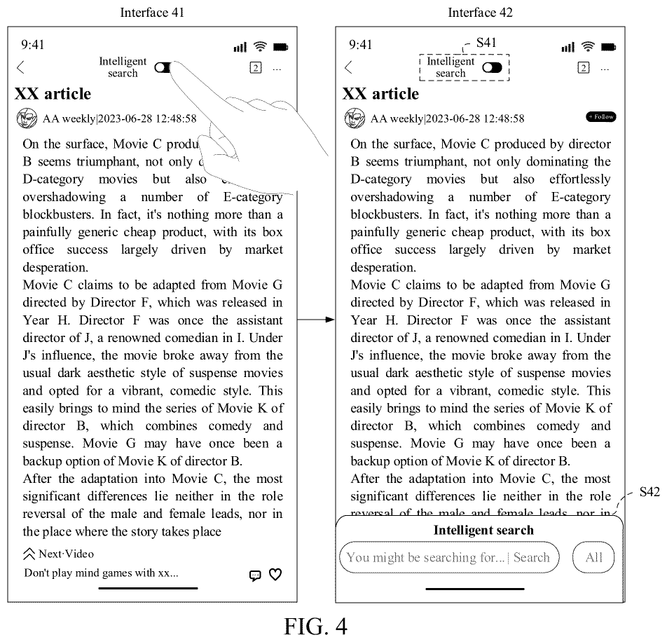

FIG. 4 is a schematic diagram of another content detail interface according to some embodiments. In FIG. 4, the switch control shown in S41 is in an on state. In this state, the object may mark the content segment in the content detail interface, and then recommended search information is intelligently generated according to the object mark.

In some embodiments, the recommended search information may be directly presented in some areas (such as the bottom or other areas) of the content detail interface. In some embodiments, a search sub-interface (such as an overlay, a semi-overlay, or a pop-up window) may be presented in the content detail interface, and the recommended search information may be presented in the search sub-interface.

An implementation is as follows. A client displays, in response to an enabling operation triggered based on the switch control, the search sub-interface at the bottom of the content detail interface.

Still using FIG. 4 as an example, after the object clicks the switch control, the switch control is switched from the off state shown in an interface 41 in FIG. 4 to the on state shown in an interface 42 in FIG. 4, as shown in S41. In the on state, the search sub-interface shown in S42 in FIG. 4 is presented in the content detail interface. A blank text display box (referred to as a search box) is presented in the search sub-interface. Subsequently, recommended search information may be intelligently generated according to the content segment marked by the object, and is presented in the blank text display box.

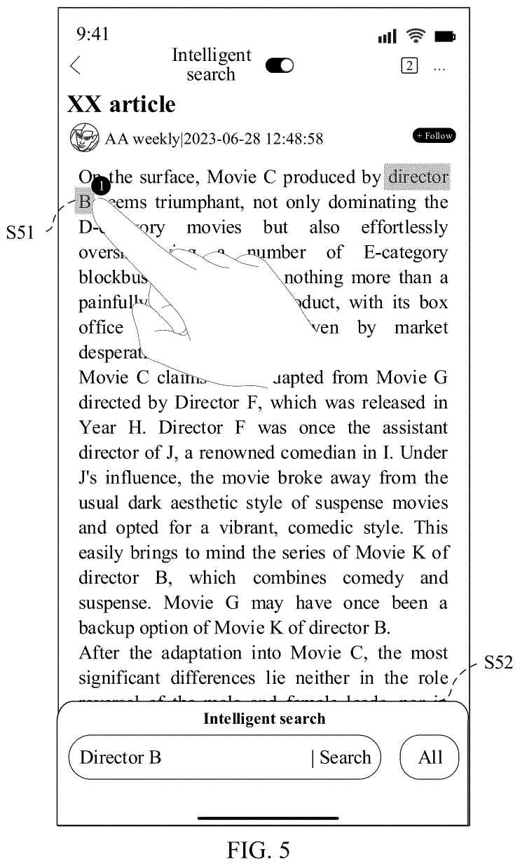

In some embodiments, when the object does not perform marking in the content detail interface, function buttons (including a search button and an all button) in the search sub-interface shown in S42 in FIG. 4 are in an inactive state and cannot be clicked (a gray state shown in the interface 42 in FIG. 4, indicating that the buttons cannot be clicked currently). However, after the object marks at least one content segment (for example, a simple text such as a word or a phrase), a related function button area is activated (a black state shown in FIG. 5, indicating that the buttons can be clicked currently).

A presentation form of the search sub-interface may be the semi-overlay shown in S42 in FIG. 4, or certainly may be another form such as a pop-up window form. This is not defined in this application.

In the foregoing implementation, the object may enable the intelligent marking search function in the content detail interface to facilitate subsequent marking of an interested or doubtful content segment.

S22: The client displays, in response to a marking operation triggered for at least one content segment in the target content, marking identifiers corresponding to the at least one content segment and at least one piece of recommended search information corresponding to the current marking operation in the content detail interface, the recommended search information being generated based on segment detail information contained in content segments marked by the current marking operation and previous marking operations. When the object marks a content segment, a corresponding marking identifier is generated and displayed at the content segment. The marking identifier is configured for representing content marked by the object in the content detail interface.

In some embodiments, the marking identifier includes, but is not limited to, some or all of the following: a selection mark and a marking sequence number of the marked content segment. The marking sequence number is configured for representing an order in which the object marks the content segment (i.e., indicating a marking order of the content segment in the target content). The selection mark may be implemented in a manner such as gray background filling, using bold, highlighting, underlining, or changing a font color. This is not defined in this specification.

In some embodiments, after the object marks the content segment, semantic analysis may be performed in real time on the segment detail information contained in the content segment marked by the object. In this process, a semantic analysis speed may further affect the presentation of corresponding recommended search information.

The segment detail information contained in the content segment is content of the content segment marked by the object, for example, information such as a text or a picture.

Specifically, after the object marks the content segment, a related function button area is activated. After the object marks the content segment for a short period of time (i.e., a preset time range), the search sub-interface in the content detail interface generates, based on semantic understanding and integration and ranking of association degrees, at least one piece of recommended search information (query) strongly related to the marked content segment so that the object may perform a proper search based on doubts or interests of the object.

The duration of the preset time range may further reflect the number of presentation times of the recommended search information. For example, when the semantic analysis speed is relatively ideal, i.e., when the recommended search information may be generated quickly, each time the object marks a content segment, the recommended search information may be presented in the content detail interface in time. For another example, when the semantic analysis speed is not ideal, i.e., when a speed of generating the recommended search information is slow, the object may wait for a period of time after marking is completed. In the waiting process of the object, the object may perform marking again. In this case, each time the object marks at least one content segment (including one content segment, or including a plurality of content segments), the recommended search information may be presented in the content detail interface.

In some embodiments, based on the foregoing idea, it may be set that if the marking time of at least one content segment falls within the preset time range, each time at least one content segment is marked, at least one piece of recommended search information corresponding to this marking is displayed in the search sub-interface of the content detail interface.

The preset time range is set according to a speed of “generating recommended search information based on segment detail information contained in the content segments marked currently and previously”. When the recommended search information is generated based on the segment detail information contained in the content segments marked by the object, semantic analysis is performed according to the segment detail information, and corresponding recommended search information is generated according to a semantic analysis result. That is, the speed of generating the recommended search information may be considered as the semantic analysis speed. If the preset time range is set to 2 seconds, i.e., when the object continuously marks two or more content segments within 2 seconds, the semantic analysis speed is slower than a marking speed of the object. In this case, the recommended search information may be generated and presented only once according to all content segments marked by the object within 2 seconds and content segments marked previously. However, when a marking time interval between two content segments that are continuously marked by the object is greater than 2 seconds, each time the object performs marking, the recommended search information may be generated and presented only once based on the content segment marked currently and a content segment marked previously.

In some embodiments, after the object marks the content segment, the recommended search information corresponding to the content segment marked by the object may be generated in real time based on the segment detail information contained in the content segment marked by the object, and then presented in the content detail interface, for example, presented in the search sub-interface in the content detail interface, or presented in a bottom area in the content detail interface. Generally, there is more than one piece of recommended search information generated according to semantic analysis. Therefore, in the content detail interface, recommended search information corresponding to one content segment marked by the object may be presented, or recommended search information corresponding to a plurality of content segments marked by the object may be presented.

The foregoing two cases will be briefly described below with reference to the drawings.

FIG. 5 is a schematic diagram of a first process of marking a content segment according to some embodiments. The object marks a content segment “director B”. As shown in S51, the content segment is marked in the content detail interface in the form of gray background filling, and a corresponding marking order is presented at an upper right corner of the content segment. As shown in FIG. 5, the marking order indicates that the content segment is the first marked segment. If the object does not perform a second marking within 2 seconds, recommended search information generated based on the mark may be directly presented in the search sub-interface. For example, a piece of generated recommended search information “director B” is presented in a search box in the search sub-interface shown in S52 in FIG. 5.

In addition, when the recommended search information is presented, a related function button area is activated, indicating that the function button may be currently clicked. For example, the object may click a search button, and “director B” is used as a search word for searching. For another example, the object may click an all button to view more candidate search information, and so on.

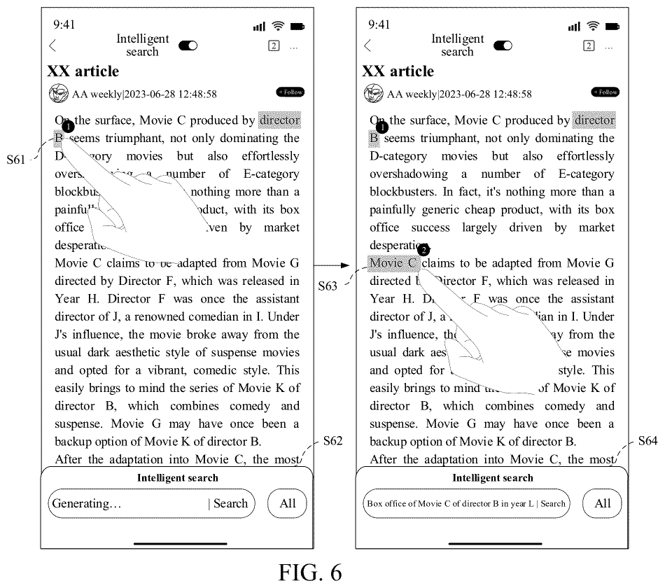

FIG. 6 is a schematic diagram of a second process of marking a content segment according to some embodiments. An interface 61 in FIG. 6 exemplarily shows that the object first marks a first content segment “Director B”. As shown in S61, the object may wait for a period of time after marking is completed. The recommended search information cannot be temporarily presented in the search box in the search sub-interface. Instead, a prompt “Generating . . . ” shown in S62 is presented. Within 2 seconds after the first marking, the object marks a second content segment “Movie C”. As shown in S63 in an interface 62 in FIG. 6, the object waits for a period of time after marking the second content segment. Then, in the search sub-interface shown in S64 in the interface 62 in FIG. 6, recommended search information “Box office of Movie C of director B in year L” generated according to the first and second content segments marked by the object is presented.

The case listed in FIG. 6 indicates that a marking time interval between the first mark and the second mark is within 2 seconds. In this case, when the recommended search information is not generated based on the first mark of the object (prompting “Generating . . . ” shown in S62), the object immediately performs the second mark. In this case, the recommended search information may be generated once according to the two marks, and then the recommended search information shown in S64 is presented.

However, if a marking time interval between every two markings of the object does not fall within the foregoing listed preset time range, each time after marking a content segment, the client may present a marking identifier corresponding to the content segment and at least one piece of recommended search information corresponding to this marking in the content detail interface.

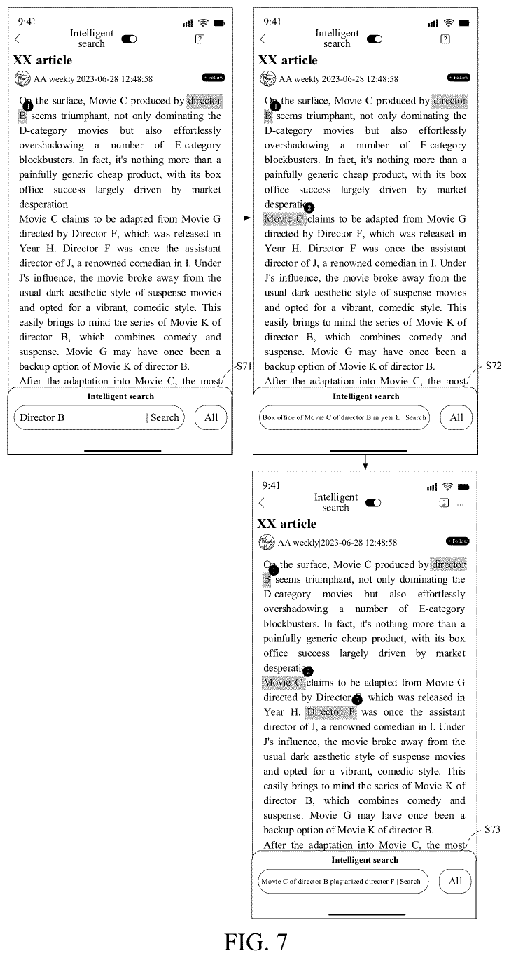

FIG. 7 is a schematic diagram of a third process of marking a content segment according to some embodiments. FIG. 7 is an example of presenting recommended search information each time after the object marks a content segment. For example, the object first marks a first content segment “Director B”, recommended search information “Director B” generated based on the content segment is presented in a search box of a search sub-interface shown in S71. Then, the object marks a second content segment “Movie C”, and recommended search information “Box office of Movie C of director B in year L” generated based on the first and second content segments is presented in a search box of a search sub-interface shown in S72. Later, the object marks a third content segment “Director F”, and recommended search information “Movie C of director B plagiarized director F” generated based on the first, second, and third content segments is presented in a search box of a search sub-interface shown in S73.

The several examples listed above are examples in which only one piece of recommended search information is presented each time. Actually, a plurality of pieces of recommended search information may further be presented each time. In addition, the number of pieces of recommended search information presented each time may be the same, or may be different.

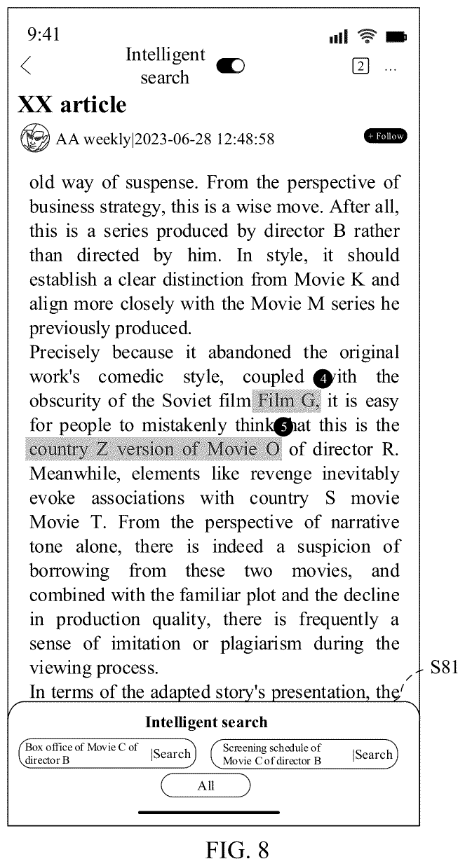

An example in which two pieces of recommended search information are presented each time is used below. FIG. 8 is a schematic diagram of recommended search information according to some embodiments. As shown in FIG. 8, the object sequentially marks five content segments with marking sequence numbers of 1 to 5, respectively, in the content detail interface. Limited by a display size of the content detail interface, FIG. 8 only exemplarily shows a fourth content segment “Movie G” and a fifth content segment “Country Z version of Movie O”.

After the object performs the fifth marking, semantic analysis is performed on segment detail information contained in the five content segments, and recommended search information is generated according to a semantic analysis result and presented in the search sub-interface. In a search sub-interface shown in S81 in FIG. 8, two pieces of recommended search information “Box office of Movie C of director B” and “Screening schedule of Movie C of director B” are presented.

In the foregoing implementation, the object may randomly mark, through an intelligent marking search function, an interested or doubtful content segment. After semantic analysis is performed on the segment detail information contained in the at least one content segment, at least one piece of recommended search information is presented in the search sub-interface. The object may click the recommended search information to directly present a search result so that the recommended search information may be rapidly generated based on the search requirement of the object when the object browses the content detail interface, thereby avoiding the problem that the object automatically summarizes keywords for searching, and improving the search efficiency. In addition, the recommended search information is carried through the search sub-interface so that the recommended search information may be conveniently distinguished from the currently browsed target content. Thus, the object intuitively acquires the recommended search information and performs a subsequent search according to the recommended search information.

In some embodiments, the marking capability provided by the client is not limited to a structure form of marked content. Using text content as an example, a content segment marked by the object may be a simple character, word, or phrase, or may be a sentence, a large block of text, or the like. If the content segment marked by the object in the content detail interface is a simple character, word, phrase, or the like, related recommended search information is directly generated according to the simple character, word, or phrase. The recommended search information may be the simple character, word, or phrase itself, or may be recommended search information generated by associating the simple character, word, or phrase with another content segment. If the content segment marked by the object in the content detail interface is a sentence, a large block of text, or the like, the core content or viewpoint may be extracted based on semantic understanding of the content segment, and then the extracted content or viewpoint is associated with other content segments marked by the object in the content detail interface, to generate recommended search information.

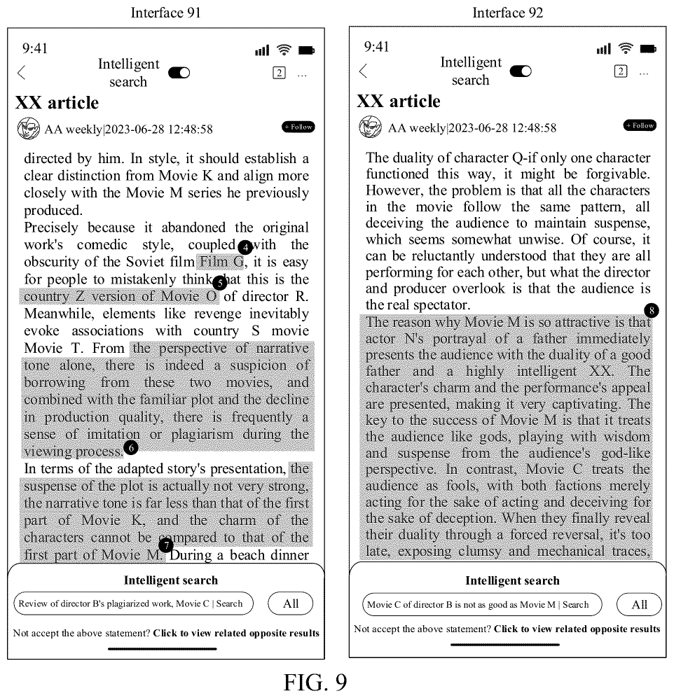

FIG. 9 is a schematic diagram of another process of marking a content segment according to some embodiments. In an interface 91 in FIG. 9, the object marks two content segments with marking sequence numbers of 6 and 7 in the target content in the content detail interface. The two content segments are each a large block of text. The content segment with a marking sequence number of 6 is “From the perspective of narrative tone, there is indeed a suspicion of borrowing from these two movies, and combined with the familiar plot and the decline in production quality, there is frequently a sense of imitation or plagiarism during the viewing process”. The content segment with a marking sequence number of 7 is “The suspense of the plot is actually not very strong, the narrative tone is far less than that of the first part of Movie K, and the charm of the characters cannot be compared to that of the first part of Movie M”.

Using the seventh marking as an example, after the foregoing content segments are marked, semantic analysis is performed on segment detail information contained in seven content segments with marking sequence numbers of 1 to 7 to obtain recommended search information “Movie C of director B is not as good as movie M”. In addition, recommended search information “Review of director B's plagiarized work, Movie (“is presented in a search sub-interface of a content detail interface 91 in FIG. 9.

In an interface 92 in FIG. 9, the object marks a content segment with a marking sequence number of 8 in the target content in the content detail interface. The content segment is a large block of text “The reason why Movie Mis so attractive is that actor N's portrayal of a father immediately presents the audience with the duality of a good father and a highly intelligent XX. The character's charm and the performance's appeal are presented, making it very captivating. The key to the success of Movie Mis that it treats the audience like gods, playing with wisdom and suspense from the audience's god-like perspective. In contrast, Movie C treats the audience as fools, with both factions merely acting for the sake of acting and deceiving for the sake of deception. When they finally reveal their duality through a forced reversal, it's too late, exposing clumsy and mechanical traces, without any character's charm”. Content extracted according to the text is “Difference between Movie C and Movie M”, and then is associated with other seven content segments marked by the object in the target content. Finally, semantic analysis is performed according to segment detail information contained in the eight content segments. Based on a semantic analysis result, the recommended search information “Movie C of director B is not as good as Movie M” is presented in the search sub-interface of the content detail interface in FIG. 9.

In some embodiments, query information (query) based on which the search is performed may be generated based on customized object annotation content, without relying on the input of the object. That is, existing content may be freely marked by the object and then automatically converted into a single query for searching. The object only may mark interested or doubtful content, and the system intelligently generates, based on the marked content and marking behaviors of the object, search queries that the object may be interested in and that are highly associated with all marked content segments (the system ranks the queries based on intention prediction of the object and association degrees of all marked content segments). Remaining unused queries (ranked later) are collectively stored in the query library for use. The object finally selects content in the query library for searching.

Some queries in the query library may be directly presented in S22, and remaining queries may be presented when the object selects to view a first search information set (which are described in detail below and are not described herein again). A query having a high association degree with the currently marked content segment is preferentially presented to the object, thereby further improving the information search efficiency.

Based on the foregoing description, searching may be directly performed according to the recommended search information intelligently generated based on the mark, for example, S23.

S23: The client displays, in response to a search operation triggered based on target recommended search information in the at least one piece of recommended search information, a search result corresponding to the target recommended search information.

The object may select one piece of target recommended search information from the at least one piece of presented recommended search information in the content detail interface and trigger a search operation based on the target recommended search information. After the search operation is triggered, the client transmits, through a terminal device, a search request generated based on the target recommended search information to a server. After receiving the search request, the server may retrieve content matching the target recommended search information from a content pool as a search result corresponding to the target recommended search information. Further, after acquiring search results corresponding to the target recommended search information, the server feeds back the search results to the terminal device, and the terminal device presents the search results through the client.

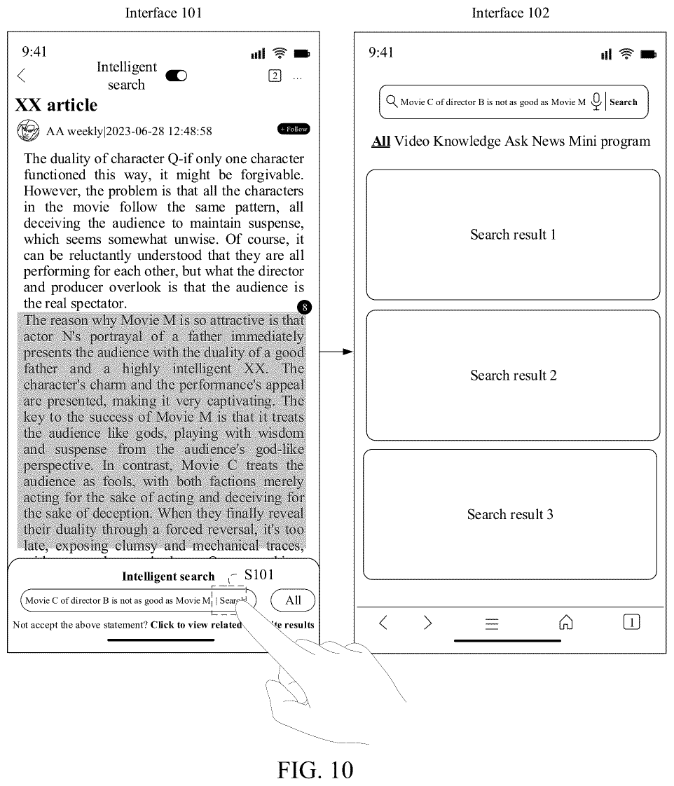

FIG. 10 is a schematic diagram of a process of information search based on target recommended search information according to some embodiments. For example, only one piece of recommended search information is currently presented in the search box of the search sub-interface, for example, “Movie C of director B is not as good as Movie M” shown in an interface 101. The object may click a “search” button S101 in the search box to use the recommended search information as target recommended search information to search for related content. An interface 102 is presented, for example, a search result corresponding to “Movie C of director B is not as good as Movie M” is presented.

In the foregoing implementation, the object may further perform an information search based on the recommended search information. In the search process, the object performs marking only according to its own search requirement and does not may spend time thinking and manually inputting a search keyword, thereby effectively improving the search efficiency. In addition, based on better satisfying the search requirement of the object, this manner may further help the object to discover and acquire more related information, thereby improving the search experience of the object and improving the richness of acquired information.

In some embodiments, the process of generating the recommended search information may be implemented through some methods based on NLP and machine learning. For example, the server understands and identifies the marked content segments using the NLP technology, ranks the recommended search information according to association degrees between the generated recommended search information and the marked content segments, determines recommended search information within a specified order range, and returns the recommended search information to the terminal device. The recommended search information is presented in the content detail interface (for example, presented in the search sub-interface) through the client installed on the terminal device. Details may refer to the following embodiments and are not described herein again.

In the foregoing implementation, the recommended search information may be rapidly and accurately generated through the artificial intelligence technology so that when browsing target content (especially content such as characters, and news and current affairs having complex character relationships), the object may not only explore content through search information recommended by a system, but also mark interested content and events through an operation of the object, and perform deeper information search according to the content, providing a more personalized search experience, and greatly satisfying the search requirement of the object.

In some embodiments, there may be cases in which the recommended search information presented in the search sub-interface cannot satisfy a current search requirement of the object, or the object wants to view more selectable recommended search information.

In these cases, an implementation is as follows.

An option viewing control is provided in the content detail interface, for example, provided in a bottom area of the content detail interface, or in the search sub-interface. The search sub-interface is still used as an example below.

The object may trigger the option viewing control of the search sub-interface in the content detail interface. The client displays, in response to a viewing operation triggered by the object based on the option viewing control, first search information sets corresponding to the marked content segments in the content detail interface.

In some embodiments, the first search information sets corresponding to the marked content segments may be presented in the search sub-interface in the content detail interface.

Each first search information set contains one or more pieces of first search information. The first search information is intelligently generated according to the content segments marked by the object, containing at least the “at least one piece of recommended search information” presented in S22 and candidate search information generated based on content segments marked currently and previously. Association degrees between the at least one piece of recommended search information and the content segments satisfy a preset association condition. For example, the ranking of the association degrees with the content segments is within a specified sequence range. However, association degrees between the candidate search information and the content segments do not satisfy the preset association condition. For example, the ranking of the association degrees with the content segments does not fall within the specified sequence range.

The specified sequence range may refer to a sequence range specified when the association degrees are ranked in ascending order or in descending order, for example, topN representing the highest association degree, N being a positive integer. For example, when N is set to 1, recommended search information having the highest association degree is directly presented in S22. For another example, when N is set to 2, recommended search information having the highest association degree and the second highest association degree is directly presented in S22, and so on.

In some embodiments, the ranking of the association degrees may refer to ranking according to at least one of content association degrees with the content segments and intention association degrees with a search intention of the object. The ranking rule may be that ranking is performed in descending order of association degrees. The at least one piece of recommended search information within the specified sequence range may be a piece of recommended search information having the highest association degree in the first search information set, or may be two pieces of recommended search information having the highest association degree and the second highest association degree, or the like.

In some embodiments, the option viewing control is an “all” control in the search sub-interface in the content detail interface. When the object marks at least one content segment, marking identifiers corresponding to the at least one content segment are presented in the content detail interface. In this case, at least one piece of corresponding recommended search information is presented in the search sub-interface in the content detail interface, and the object clicks the “all” control in the search sub-interface to view the first search information set that includes at least one piece of recommended search information (which may be marked as an optimal query) and other candidate search information (which may be marked as a query history that is not ranked above) and is presented in the search sub-interface.

For example, query details contain an intelligent search module. With changes of content marked by the object and a proportion weight of text, a query produced by the intelligent search also dynamically changes correspondingly. Content in the intelligent search module contains query content (containing an optimal query and the query that is not ranked above) previously outputted in the bottom search box, an optimal query up to the last marked content, and a related query that is not ranked above, and is ranked according to nodes marked with time and content.

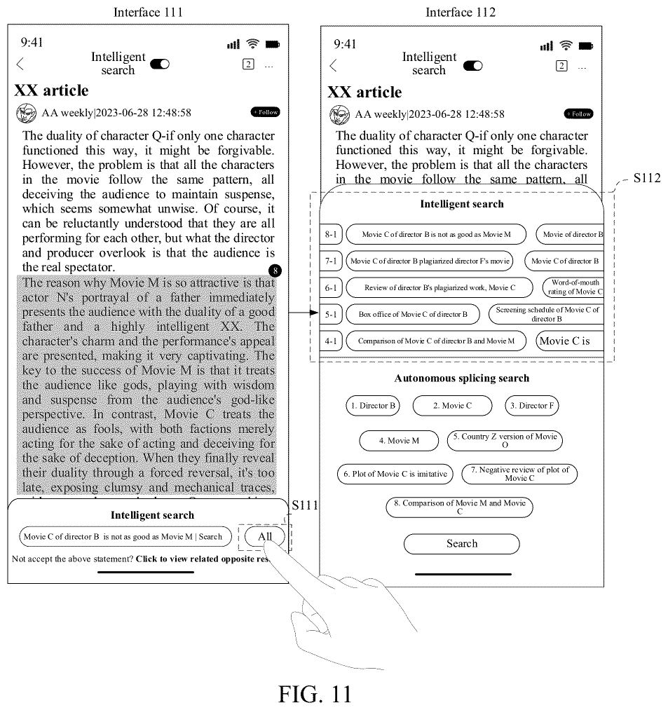

FIG. 11 is a schematic diagram of a first search information set according to some embodiments. The object sequentially marks eight content segments in the content detail interface. An interface 111 in FIG. 11 represents a content segment with a marking sequence number of 8 marked by the object, and recommended search information “Movie C of director B is not as good as Movie M” generated according to the eight content segments is presented in a search sub-interface in an interface 111 in FIG. 11. If the recommended search information cannot satisfy the search requirement of the object, the object clicks an “all” control shown in S111 in FIG. 11, and a content detail interface is shown in an interface 112 in FIG. 11. A range of a semi-overlay of the search sub-interface is increased, and an intelligent search module shown in S112 in FIG. 11 is presented in the semi-overlay. First search information sets associated with the content segments with the marking sequence numbers of 1 to 8 are presented in the intelligent search module. Each first search information set includes all recommended search information that is associated and generated according to content segments marked by the object currently and previously. For example, “8-1”, “7-1”, “6-1”, “5-1”, and “4-1” in S112 are identifiers of these first search information sets.

All recommended search information in 8-1 is the first search information set corresponding to the content segment with a marking sequence number of 8. First search information in the first search information set includes all search information (referred to as first search information) generated according to the marked content segments 1 to 8. The search information is ranked in descending order of association degrees. “Movie C of director B is not as good as Movie M” with the highest association degree ranks first, and the search information with the highest association degree is used as recommended search information and presented in the search sub-interface in the interface 111 in FIG. 11. Similarly, all search information in 7-1 is the first search information set corresponding to the content segment with a marking sequence number of 7. First search information in the first search information set includes all search information generated according to the marked content segments 1 to 7, and the search information is ranked according to descending order of association degrees. “Movie C of director B plagiarized director F's movie” with the highest association degrees ranks first. Similarly, after the object marks the content segment 7, the search information is further used as recommended search information and presented in the search box of the search sub-interface.

In some embodiments, the object may view more recommended search information by sliding. Specifically, the object may view, by sliding up and down, more first search information sets that are not currently displayed. For example, the object may further view first search information sets “3-1”, “2-1”, and “1-1” by sliding up. The object may further view, by sliding left and right, more first search information that is not currently displayed in each first search information set.

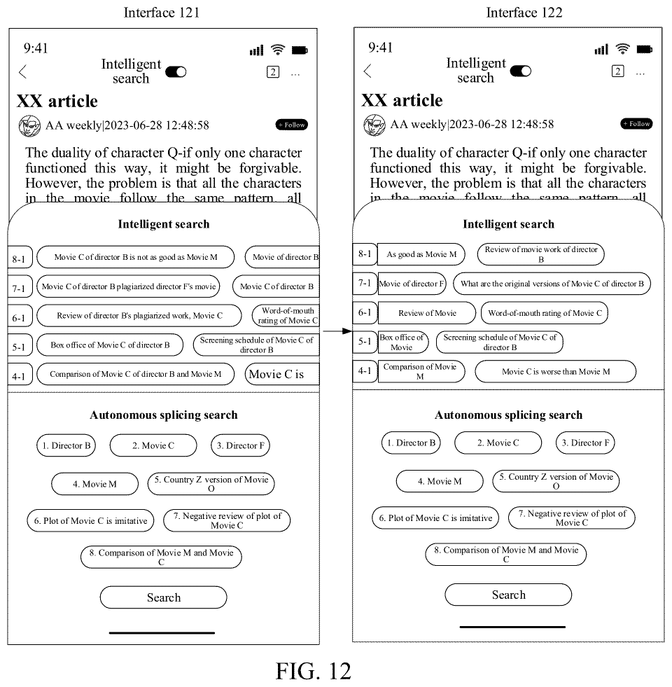

FIG. 12 is a schematic diagram of another first search information set according to some embodiments. An interface 121 in FIG. 12 represents a home page of the intelligent search module that is presented after the object triggers an “all” control in a search sub-interface in a content detail interface. The home page contains some first search information. If the object may view more first search information, the object may slide left in an area in which the intelligent search module is located. In this case, the intelligent search module is shown in an interface 122 in FIG. 12. The interface 122 presents more first search information such as “Review of movie work of director B”, “What are the original versions of Movie C of director B”, “Word-of-mouth rating of Movie C”, “Screening schedule of Movie C of director B”, and “Movie C is worse than Movie M”.

In the foregoing implementation, the object may freely mark interested or doubtful content in the target content and does not may convert the content into a keyword for searching. The first search information set is generated based on the content marked by the object so that the object may select any one piece of search information in the first search information set according to a search requirement of the object, thereby shortening a search path of the object, and providing richer search suggestions for the object.

Based on the foregoing description, the object may directly perform searching based on the first search information intelligently generated according to the mark. An implementation is as follows.

The client displays, in response to a search operation triggered by the object based on any piece of first search information, a search result corresponding to the any piece of first search information.

The object may select a piece of target first search information from a plurality of pieces of presented first search information in the search sub-interface and trigger a search operation based on the target first search information. After the search operation is triggered, a search request generated based on the target first search information is transmitted to a server through a terminal device. After receiving the search request, the server may retrieve content matching the target first search information from a content pool as a search result corresponding to the target first search information. Further, after acquiring search results corresponding to the target first search information, the server feeds back the search results to the terminal device, and the terminal device presents the search results through the client.

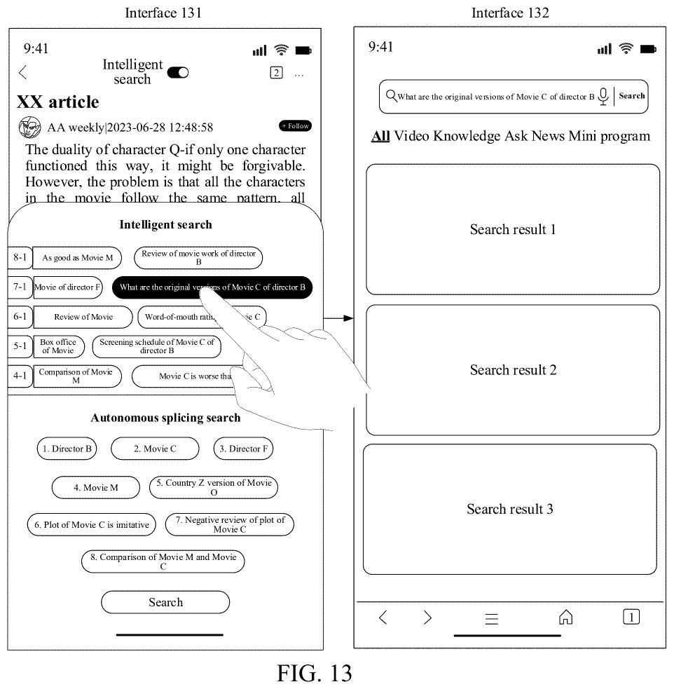

FIG. 13 is a schematic diagram of a process of information search based on target first search information according to some embodiments. For example, the intelligent search module in the search sub-interface currently presents a plurality of pieces of first search information. The object may select one piece of first search information and use the selected first search information as target first search information to search for related content. An interface 132 is presented, for example, a search result corresponding to “What are the original versions of Movie C of director B” is presented.

In the foregoing implementation, the object automatically selects first search information in a first search information set according to a search requirement and directly views a search result by clicking the first search information so that the object completes a deeper understanding of related information according to the search requirement of the object, thereby shortening a search path, and improving the search efficiency.

In some embodiments, if the recommended search information presented in the search sub-interface and the first search information presented in the intelligent search module still cannot satisfy the search requirement of the object, when the object triggers an option viewing control of a search sub-interface in a content detail interface, in response to a viewing operation triggered by the object based on the option viewing control, in addition to displaying the first search information set, the at least one piece of second search information corresponding to the marked content segments may further be displayed in the content detail interface.

In some embodiments, the at least one piece of second search information corresponding to the marked content segments may be displayed in the search sub-interface in the content detail interface.

Specifically, the option viewing control is an “all” control in the search sub-interface in the content detail interface. When the object marks at least one content segment, marking identifiers corresponding to the at least one content segment are presented in the content detail interface. In this case, at least one piece of corresponding recommended search information is presented in the search sub-interface in the content detail interface. In addition to viewing the first search information set described above by clicking the “all” control in the search sub-interface, the object may further view at least one piece of second search information corresponding to the marked content segments.

The second search information is search information generated based on the content segment marked currently, each content segment may correspondingly generate at least one piece of second search information, and the number of pieces of second search information corresponding to different content segments may be the same or may be different.

In some embodiments, different from the first search information, the second search information may be provided for the object to autonomously perform splicing search. Therefore, the second search information is generated only according to the content segment marked currently, without considering the impact of other content segments marked previously on the content segment marked currently.

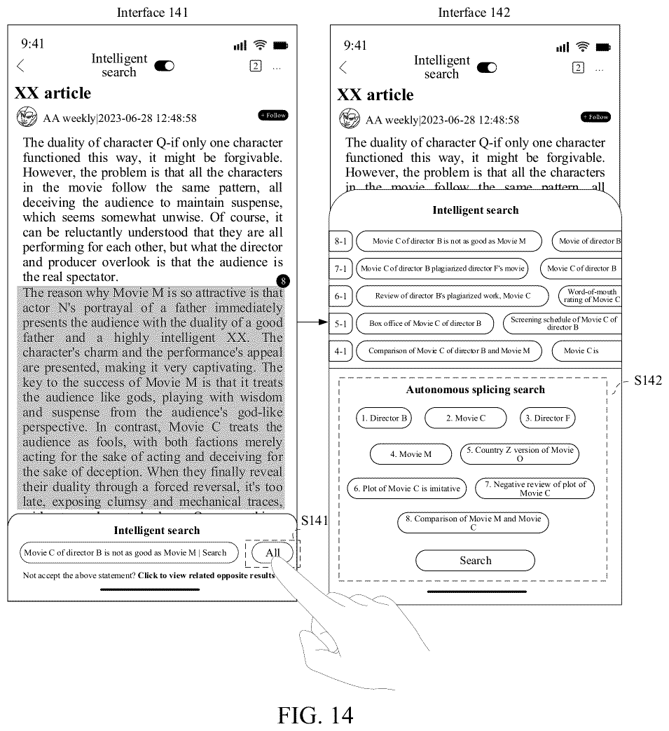

Specifically, after the object clicks the “all” control of the search sub-interface, in addition to the intelligent search module listed above, query details further contain an autonomous splicing search module. The system's capability to understand the marked content and calculate the weights may not be able to satisfy the ever-changing requirements of the object. Therefore, a query may be integrated and outputted by providing the object with a capability of splicing marked contents autonomously and adjusting the sequence through the autonomous splicing search module. When the first search information in the intelligent search module in FIG. 11 to FIG. 13 does not satisfy expectation of the object, the object may further perform search using the autonomous splicing search module, as shown in FIG. 14.

FIG. 14 is a schematic diagram of second search information according to some embodiments. The object sequentially marks eight content segments in the content detail interface. A marking identifier of a content segment with a marking sequence number of 8 marked by the object is displayed in an interface 141 in FIG. 14, and recommended search information “Movie C of director B is not as good as Movie M” generated according to the eight content segments is presented in a search sub-interface in the interface 141. If the recommended search information cannot satisfy the search requirement of the object, the object clicks an “all” control shown in S141 in FIG. 14, and a content detail interface 142 presents an autonomous splicing search module shown in S142 in FIG. 14. There are eight pieces of second search information in the autonomous splicing search module, for example, second search information “1. Director B” generated based on a content segment 1, second search information “2. Movie C” generated based on a content segment 2, second search information “3. Director F” generated based on a content segment 3, second search information “4. Movie M” generated based on a content segment 4, second search information “5. Chinese version of Movie O” generated based on a content segment 5, second search information “6. Plot of Movie C is imitative” generated based on a content segment 6, second search information “7. Negative review of plot of Movie C” generated based on a content segment 7, and second search information “8. Comparison of Movie M and Movie C” generated based on a content segment 8.

In the foregoing implementation, at least one piece of corresponding second search information is generated for all content segments currently marked by the object so that the object may search any one or more currently marked content segments at any time and subsequently perform an autonomous splicing search on the second search information, thereby improving the freedom of searching, and ensuring that basic information on which the searching is based better satisfies the requirement of the object.

In some embodiments, after the object triggers the option viewing control of the search sub-interface in the content detail interface and displays the second search information, a search operation may further be triggered based on at least one piece of second search information. An implementation is as follows.

The client displays, in response to the search operation triggered by the object based on the at least one piece of second search information, a search result corresponding to spliced search information.

The spliced search information is obtained by splicing the at least one piece of second search information.

Specifically, after the object triggers the option viewing control of the search sub-interface in the content detail interface and presents the second search information, the at least one piece of second search information may be sequentially clicked. The at least one piece of second search information selected by the object may be spliced according to a clicking sequence of the object to form spliced search information. An information search is performed according to the spliced search information, and a corresponding search result is presented.

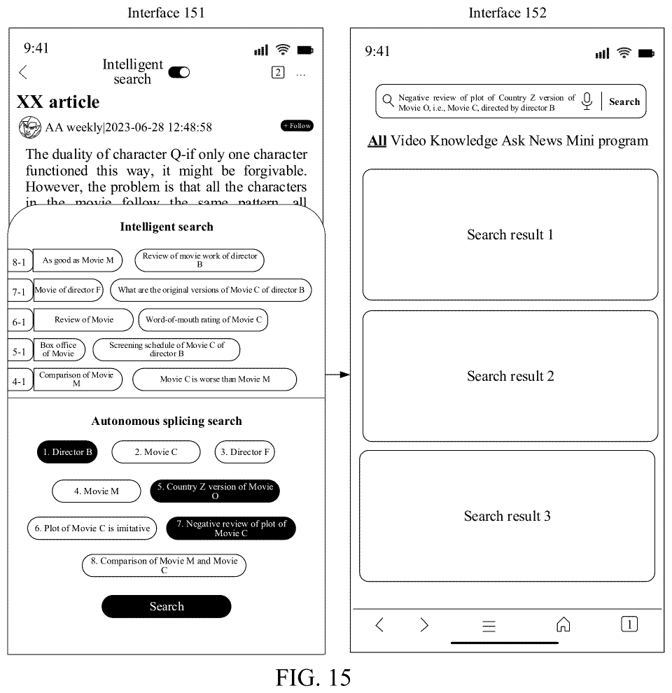

FIG. 15 is a schematic diagram of a process of autonomous splicing search based on second search information according to some embodiments. An interface 151 in FIG. 15 indicates that after the object triggers an “all” control of a search sub-interface in a content detail interface, an autonomous splicing search module is presented in the content detail interface. The autonomous splicing search module contains eight pieces of second search information, for example, “1. Director B”. The object may click at least one of the eight pieces of second search information to generate spliced search information. For example, the object clicks three pieces of second search information, i.e., “1. Director B”, “5. Chinese version of Movie O”, and “Negative review of plot of Movie C”, in the autonomous splicing search module. In this case, the client may transmit the three pieces of second search information to the server, and the server performs splicing to generate spliced search information “Negative review of plot of Country Z version of Movie O, i.e., Movie C, directed by director B”. Further, a matching search result is retrieved from a content pool based on the spliced search information, and a successfully matched search result is returned to the client. The search result of the spliced search information is presented to the object through the client, as shown in an interface 152 in FIG. 15.

In the foregoing implementation, the second search information is flexibly combined and ranked through the object so that the object obtains a more personalized search experience, thereby helping the object explore interested content more deeply and precisely.

In some embodiments, positive and negative tendencies, such as “accept” (want to view more, for example, view the foregoing first search information and second search information “)” and “not accept” (view a reverse certificate, for example, view the following third search information”), of the outputted query may be adjusted in advance. When the query provided by the system does not satisfy the requirement of the object, the object may click the generated query library and autonomously search according to the query provided by the system.

An implementation is as follows. In some embodiments, a reverse search of the object is further supported. Specifically, after the object performs marking each time, at least one piece of recommended search information may be presented in the content detail interface, and reverse search prompt information may be presented simultaneously. In some embodiments, the reverse search prompt information may be presented when the recommended search information is presented only when the recommended search information presented in S22 satisfies a preset reverse condition. An implementation is as follows.

In some embodiments, calculation may further be performed based on an NLP model and a search result. After it is determined that the recommended search information has search information having a search result semantically opposite to the search result corresponding to the recommended search information, the reverse search prompt information is further displayed in the search sub-interface. When the object accepts content of the recommended search information in the search box of the current search sub-interface, a search may be directly performed. When the object does not accept or wants to see an opposite opinion, related search results in the content pool may further be directly and rapidly acquired through reverse adjustment based on the reverse search prompt information.

Specifically, the reverse search prompt information is displayed in the content detail interface. The reverse search prompt information is configured for prompting a manner of searching for content that is semantically opposite to the search result corresponding to the at least one piece of recommended search information. The reverse search prompt information may be in the form of a text link, a button, or the like. The object may click (or may be other operations such as a long press; this is not defined herein) the reverse search prompt information to trigger a reverse search operation. The client displays, in response to the reverse search operation triggered based on the reverse search prompt information, third search information associated with the at least one piece of recommended search information in the content detail interface.

Content of a search result corresponding to the third search information is semantically opposite to content of a search result corresponding to associated recommended search information. The reverse search prompt information may be presented below the search box in the search sub-interface, or may be presented at another position in the content detail interface. This is not limited to being presented in the search sub-interface, and is not limited to being presented below the search box in the search sub-interface.

For example, when the object does not accept the recommended search information in the search sub-interface, and the search sub-interface presents the reverse search prompt information, the object may click the reverse search prompt information to trigger to present, below at least one piece of recommended search information in the search sub-interface, third search information corresponding to the recommended search information. A search result corresponding to the third search information is semantically opposite to the search result corresponding to the recommended search information.

Further, in addition to presenting the third search information opposite to the at least one piece of recommended search information in S22, third search information corresponding to other first search information may further be presented in the search sub-interface. That is, an implementation is as follows.

The client displays, in response to the reverse search operation triggered based on the reverse search prompt information, the third search information associated with the at least one piece of recommended search information and third search information associated with the candidate search information in the search sub-interface of the content detail interface.

For example, after the object clicks the reverse search prompt information, the client presents, in response to the reverse search operation triggered based on the reverse search prompt information, the third search information associated with the at least one piece of recommended search information and the third search information associated with the candidate search information in the intelligent search module in the search sub-interface of the content detail interface.

The candidate search information is generated based on content segments marked currently and previously, and association degrees between the candidate search information and the content segments are lower than association degrees between the recommended search information and the content segments.

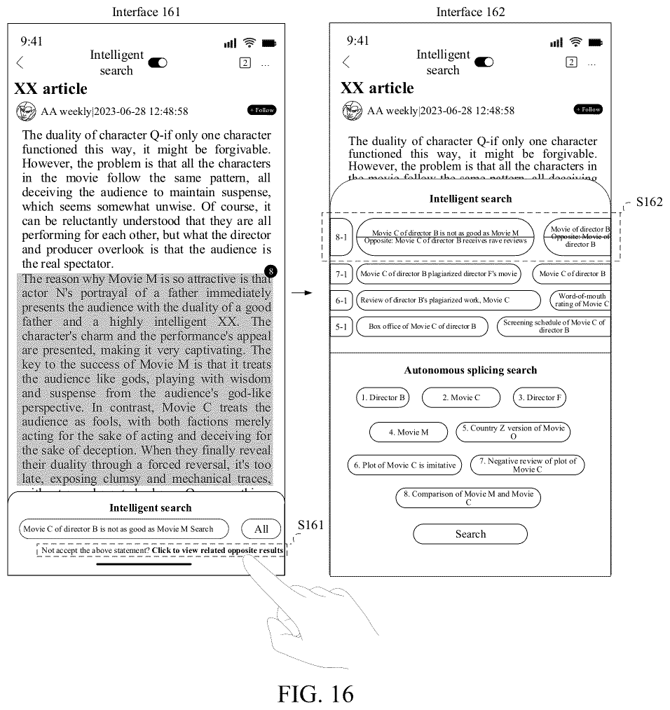

FIG. 16 is a schematic diagram of third search information according to some embodiments. An interface 161 in FIG. 16 indicates that the object marks an interested content segment in a content detail interface. For example, after a content segment 8 is marked, corresponding recommended search information “Movie C of director B is not as good as Movie M” is presented in a search box of a search sub-interface. Based on an NLP model and search result calculation, it is determined that the recommended search information has a search result “Movie C of director B receives rave reviews” semantically opposite to its corresponding search result. Further, reverse search prompt information “Not accept the above statement? Click to view related opposite results” shown in S161 in FIG. 16 is presented in the search sub-interface. If the object does not accept the recommended search information “Movie C of director B is not as good as Movie M”, the object may click “Click to view related opposite results” in the reverse search prompt information to enter an interface 162 in FIG. 16. Recommended search information in 8-1 contained in an intelligent search module in the interface 162 not only contains original first search information, but also contains third search information associated with the first search information, for example, the third search information “Movie C of director B receives rave reviews” associated with the first search information “Movie C of director B is not as good as Movie M”. A search result corresponding to the third search information is semantically opposite to a search result corresponding to the first search information.

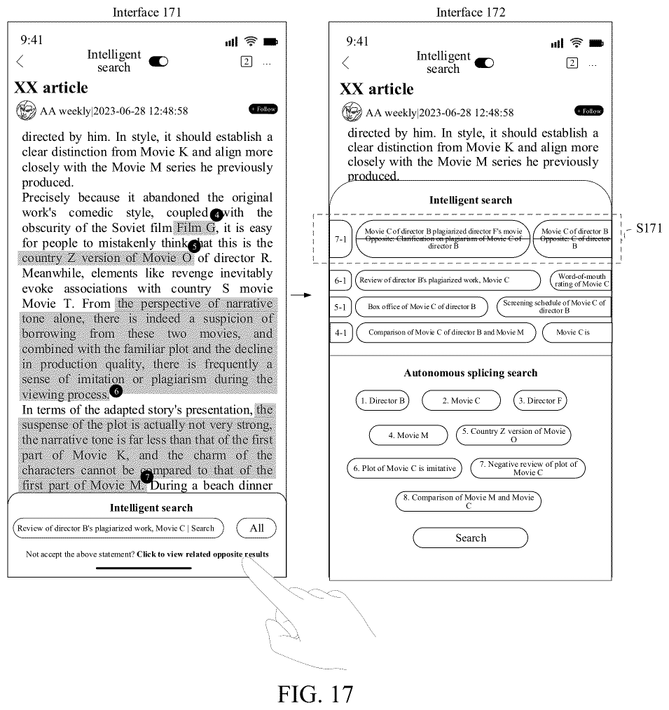

FIG. 17 is a schematic diagram of another third search information according to some embodiments. An interface 171 in FIG. 17 indicates that the object marks an interested content segment in a content detail interface. For example, after a content segment 7 is marked, corresponding recommended search information “Review of director B's plagiarized work, Movie C” is presented in a search box of a search sub-interface. Based on an NLP model and search result calculation, it is determined that the recommended search information has a search result semantically opposite to its corresponding search result. Further, reverse search prompt information “Not accept the above statement? Click to view related opposite results” shown in FIG. 17 is presented in the search sub-interface. If the object does not accept the recommended search information “Review of director B's plagiarized work, Movie C”, the object may click “Click to view related opposite results” in the reverse search prompt information to enter an interface 172 in FIG. 17. Recommended search information in 7-1 contained in an intelligent search module in the interface 172 not only contains original first search information, but also contains third search information associated with the first search information, for example, the third search information “Clarification on plagiarism of Movie C of director B” associated with the first search information “Review of director B's plagiarized work, Movie C”. A search result corresponding to the third search information is semantically opposite to a search result corresponding to the first search information.

In addition, after the object clicks the reverse search prompt information, the client may present, in response to a reverse search operation triggered by the object based on the reverse search prompt information, the third search information associated with the first search information in the intelligent search module in the search sub-interface of the content detail interface.

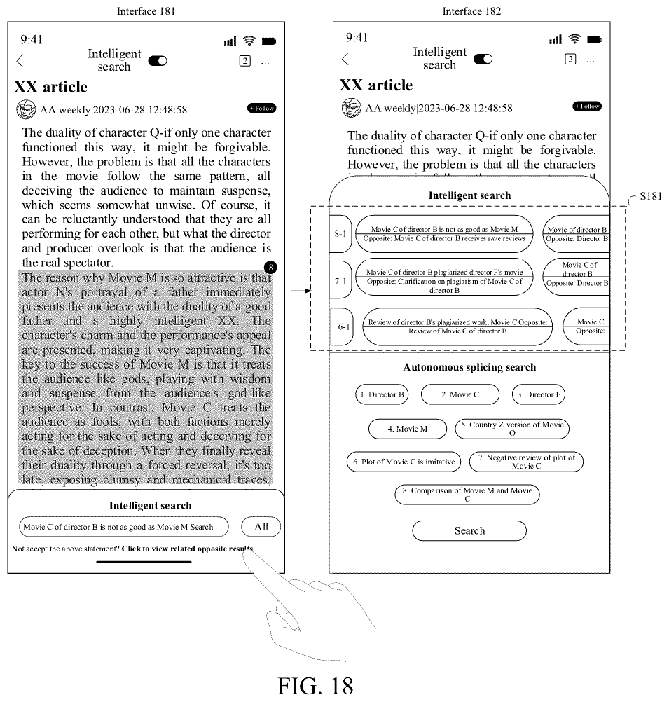

FIG. 18 is a schematic diagram of yet another third search information according to some embodiments. An interface 181 in FIG. 18 indicates that the object marks an interested content segment in a content detail interface. For example, after a content segment 8 is marked, corresponding recommended search information “Movie C of director B is not as good as Movie M” is presented in a search box of a search sub-interface. Based on an NLP model and search result calculation, it is determined that the recommended search information has a search result semantically opposite to its corresponding search result. Further, reverse search prompt information “Not accept the above statement?” Click to view related opposite results” shown in FIG. 18 is presented in the search sub-interface. If the object does not accept the recommended search information “Movie C of director B is not as good as Movie M”, the object may click “Click to view related opposite results” in the reverse search prompt information to enter an interface 182 in FIG. 18. Recommended search information in 8-1 to 1-1 contained in an intelligent search module in the interface 182, i.e., recommended search information corresponding to all content segments currently marked by the object, not only contains original first search information, but also contains third search information associated with the first search information, as partially shown in S181: third search information “Review of Movie C of director B” associated with first search information “Review of director B's plagiarized work, Movie C” in 6-1, third search information “Clarification on plagiarism of Movie C of director B” associated with the first search information “Movie C of director B plagiarized movie of director F” in 7-1, and third search information “Movie C of director B receives rave reviews” associated with the first search information “Movie C of director B is not as good as Movie M” in 8-1, and the like. A search result corresponding to the third search information is semantically opposite to a search result corresponding to the first search information.

In the foregoing implementation, by generating the third search information, this application may better satisfy a reverse search requirement of the object, which may not only improve the search efficiency, but also help the object to discover and acquire more related information, thereby improving the search experience of the object, and obtaining other information opposite to a viewpoint of the marked content segment.

In an implementation, if the object is interested in the third search information, the object may directly click the third search information to perform information search according to the third search information. Specifically, the client displays, in response to a search operation triggered by the object based on any piece of third search information, a search result corresponding to the any piece of third search information.

Specifically, after responding to the search operation triggered by the object based on the any piece of third search information (which may be recorded as target third search information), the client transmits a corresponding search request to the server. After receiving the search request, the server may retrieve content matching the target third search information from a content pool as a search result corresponding to the target third search information. Further, after acquiring search results corresponding to the target third search information, the server feeds back the search results to the terminal device, and the terminal device presents the search results through the client.

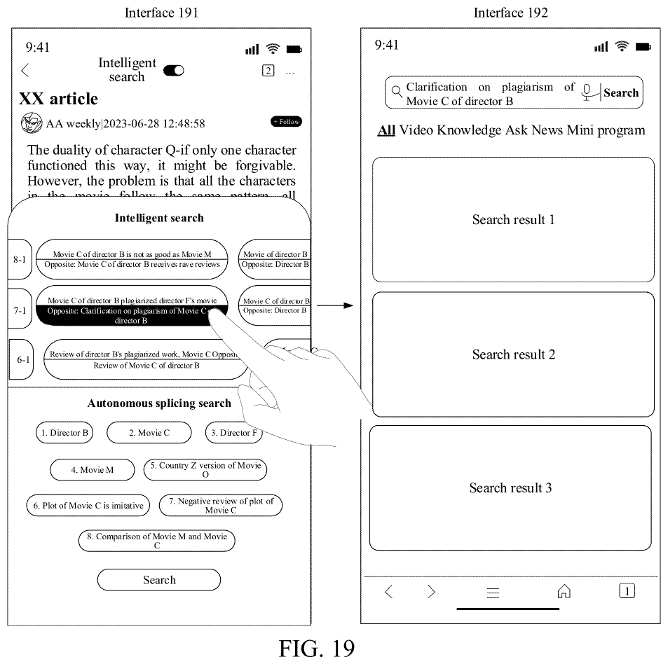

FIG. 19 is a schematic diagram of presenting a search result based on third search information according to some embodiments. In an interface 191 in FIG. 19, recommended search information in 8-1 to 1-1 contained in an intelligent search module in the interface 191, i.e., recommended search information corresponding to all content segments currently marked by the object, not only contains original first search information, but also contains third search information associated with the first search information, for example, third search information “Clarification on plagiarism of Movie C of director B” associated with the first search information “Movie C of director B plagiarized director F's movie” in 7-1. A search result corresponding to the third search information is semantically opposite to a search result corresponding to the first search information. The object clicks the third search information so that the third search information is used as target third search information to search for related content. The interface 192 is presented, for example, a search result corresponding to “Clarification on plagiarism of Movie C of director B” is presented.

In the foregoing implementation, the object clicks the third search information in the intelligent search interface and directly displays a search result semantically opposite to the content segment marked by the object, thereby better satisfying a reverse search requirement of the object. This may not only improve the search efficiency, but also help the object to discover and acquire more related information, thereby improving the search experience of the object.

In some embodiments, the reverse search prompt information is presented in the content detail interface, and whether the recommended search information presented in S22 satisfies a preset reverse condition may be analyzed first. An implementation is as follows. Whether there is controversial recommended search information among the at least one piece of recommended search information displayed in the content detail interface is determined. When it is determined that there is controversial recommended search information, the reverse search prompt information is displayed in the content detail interface.

Specifically, after the system determines an intelligent query based on all content segments marked by the object, and determines, based on database retrieval and semantic understanding, that the query is “controversial”, the system activates a reverse search function (for example, presenting the reverse search prompt information). That is, after the “controversial” query is originally outputted, a detail page of the “controversial” query is entered from a reverse search button, and the object may directly obtain an opposite query (i.e., the third search information herein) of the “controversial” query in the detail page of the query to quickly achieve a search purpose.

In some embodiments, when analyzing whether the recommended search information is controversial, analysis manners include, but are not limited to, the following two manners.

First analysis manner: Perform authenticity verification on the search result corresponding to the recommended search information to determine whether the recommended search information is controversial.

Specifically, when at least one piece of recommended search information is generated according to marking information of the object, authenticity verification may further be performed on the at least one piece of recommended search information in advance. For search results corresponding to some recommended search information, true and false information descriptions may exist. For example, a search result corresponding to a piece of recommended search information is a fact about an event or a person, and the fact may be incorrectly reported or deliberately distorted. In this case, the recommended search information is controversial.

In this case, the authenticity of the search result may be verified using a fact-checking technology. Specifically, this may be implemented by comparing information from a plurality of sources, querying an authoritative database, and using a pre-trained fact-checking model. Whether a fact is incorrectly reported or deliberately distorted is analyzed to determine whether corresponding recommended search information (query) is controversial.

Second analysis manner: Perform opposite viewpoint recognition on the search result corresponding to the recommended search information through a text classification technology; and determine, according to a recognition result, whether the recommended search information is controversial.

Specifically, when at least one piece of recommended search information is generated according to marking information of the object, opposite viewpoint recognition may further be performed on the at least one piece of recommended search information in advance. For search results corresponding to some recommended search information, there may be opposite viewpoints. For example, a search result corresponding to a piece of recommended search information is an opinion about a policy or a theory, and the opinion may vary from person to person. In this case, if different objects have different opinions about the policy or the theory, the recommended search information is controversial.

In this case, different opinions may be recognized using the text classification technology. If it may be recognized that a search result of a piece of recommended search information (query) has a plurality of viewpoints or positions, and proportions of the plurality of viewpoints or positions are similar, it may be determined that the recommended search information is controversial.

Then, according to the requirement and interest of the object, a search result containing a plurality of opinions may be provided, or according to the position of the object, a search result satisfying the position of the object may be provided.

In some embodiments, controversial recommended search information may be determined in any one of the foregoing manners. If there is controversial recommended search information in the at least one piece of recommended search information presented in S22, the reverse search prompt information may be presented in the search sub-interface. For example, if it is determined, based on the foregoing first analysis manner, that the at least one piece of recommended search information presented in S22 does not contain confrontational recommended search information, no prompt may be made, or further determination is performed with reference to the second analysis manner. For another example, if it is determined, based on the foregoing second analysis manner, that the at least one piece of recommended search information presented in S22 does not contain confrontational recommended search information, no prompt may be made, or further determination is performed with reference to the first analysis manner, and so on.

Controversial recommended search information is determined with reference to the foregoing two aspects. If it is determined that there is controversial recommended search information in the at least one piece of recommended search information currently presented in the content detail interface, the reverse search prompt information is presented in the search sub-interface. If it is determined that there is no controversial recommended search information in the at least one piece of recommended search information currently presented in the content detail interface, the reverse search prompt information is not presented in the search sub-interface.

In the foregoing implementation, the third search information is presented with reference to authenticity verification and opposite viewpoint recognition to provide more authentic and multi-perspective information to the object, thereby satisfying the diversified search requirement of the object.

In some embodiments, according to the content marked by the object, the system may flexibly combine and rank the search results through association degree analysis and object search tendencies, thereby providing a more personalized search experience.

Specifically, when the object wants to obtain different pieces of recommended search information, a marking sequence may further be changed. In addition, the object may further cancel some marks based on the current mark. After the object cancels at least one mark in a searched marked content segment or an uninterested marked content segment, the object triggers an unmarking operation for the at least one content segment and updates displayed recommended search information in the content detail interface. The updated recommended search information is generated based on the currently marked content segments.

After the object cancels the marking operation of the at least one content segment, if the at least one content segment that is canceled is the most recently marked, semantic analysis does not may be performed again in this case, and new recommended search information is directly presented in the content detail interface according to a previous semantic analysis result. The recommended search information is essentially what has been presented previously. For example, eight content segments are marked currently, and the object cancels a content segment marked for the eighth time. Then, new recommended search information may be directly presented in the content detail interface according to a previous semantic analysis result of segment detail information contained in the 1-7 content segments. The new recommended search information is essentially the same as recommended search information presented when the object marks the seventh content segment previously.

If the at least one content segment that is canceled is not the most recently marked, semantic analysis may be performed again on segment detail information contained in the currently marked content segments, new recommended search information is generated according to a new semantic analysis result, and the recommended search information is presented in the search sub-interface in the content detail interface. For example, eight content segments are marked currently, and the object cancels a content segment marked for the sixth time. Then, semantic analysis may be performed again according to segment detail information contained in the remaining seven marked content segments, and new recommended search information is presented in the content detail interface according to a new semantic analysis result.

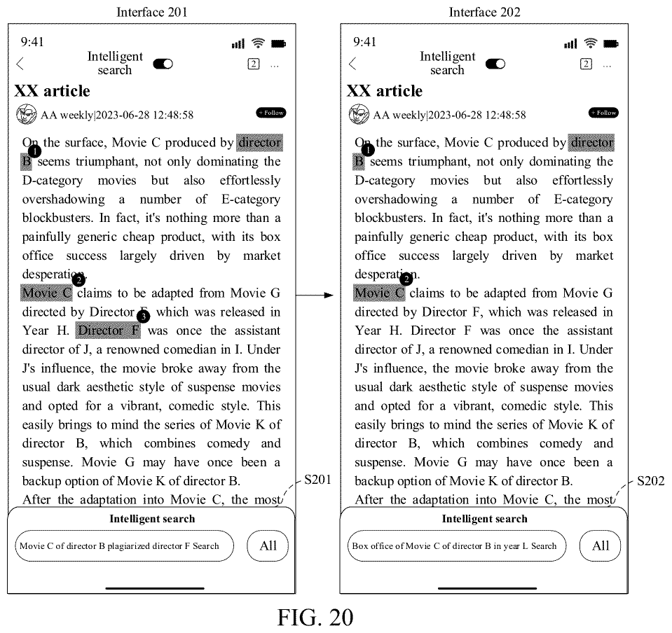

FIG. 20 is a schematic diagram of another content detail interface according to some embodiments. An interface 201 in FIG. 20 indicates that the object marks three content segments, i.e., a content segment “Director B” with a marking sequence number of 1, a content segment “Movie C” with a marking sequence number of 2, and a content segment “Director F” with a marking sequence number of 3, in a current content detail interface, and recommended search information “Movie C of director B plagiarized director F” corresponding to the three content segments is presented in a search sub-interface shown in S201 in FIG. 20. When the object completes searching based on the foregoing recommended search information, is not interested in the recommended search information, or finds that a mark is incorrect, unmarking may be performed. For example, after the object cancels marking of the content segment “Director F” with a marking sequence number of 3, an interface 202 shown in FIG. 20 may be presented. In this case, semantic analysis is performed according to the current marked content segments “Director B” and “Movie C”, and new recommended search information “Box office of Movie C of director B in year L” is generated according to a semantic analysis result and then presented in a search sub-interface shown in S202 in the interface 202.

In the foregoing implementation, after enabling an intelligent marking search function, the object may randomly mark an interested or doubtful content segment, and the recommended search information is generated in the search sub-interface according to the content segment marked by the object. After the object cancels at least one mark in a searched marked content segment or an uninterested marked content segment, the recommended search information in the search sub-interface is correspondingly updated. The recommended search information is updated in time according to marked content of the object, thereby providing more personalized searching experience for the object.

In some embodiments, after completing searching for the interested or doubtful content segment according to the requirement of the object, the object may further trigger a disabling operation based on a switch control in the content detail interface. In this case, the client disables, in response to the disabling operation triggered by the object based on the switch control, the intelligent marking search function, cancels display of the search sub-interface, and clears marking identifiers corresponding to the marked content segments displayed in the content detail interface.

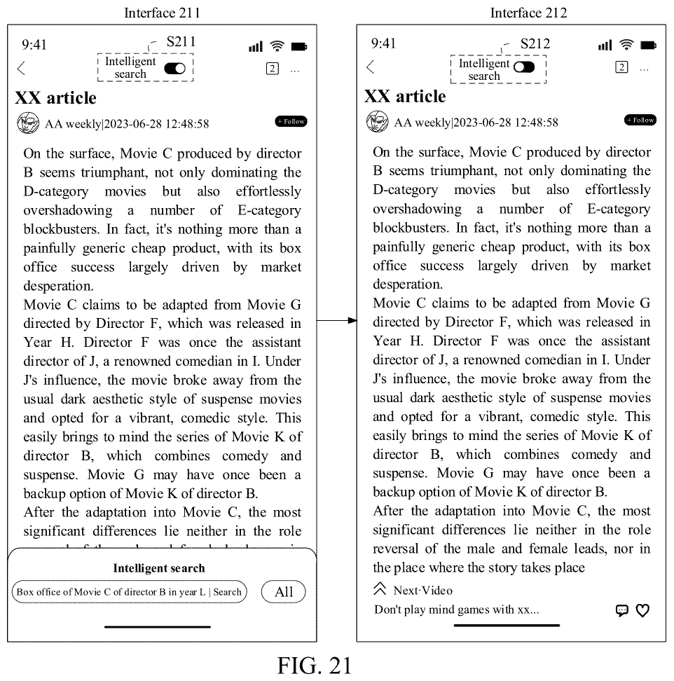

FIG. 21 is a schematic diagram of a switch control according to some embodiments. An interface 211 in FIG. 21 is that the object triggers an enabling operation of a switch control in a content detail interface. As shown in S211 in the interface 211, the switch control is in an on state, and the object marks a content segment “Director B” with a marking sequence number of 1 and a content segment “Movie C” with a marking sequence number of 2. After semantic analysis is performed on the two content segments, generated recommended search information “Box office of Movie C of director B in year L” is presented in a search sub-interface of the content detail interface in the interface 211. After the object completes searching for related content of the two content segments according to the requirement of the object, the object triggers a disabling operation of the switch control in the content detail interface, and an interface 212 in FIG. 21 is presented, as shown in S212 in the interface 212. The switch control is in an off state. In this case, the intelligent marking search function is disabled, display of the search sub-interface in the content detail interface is canceled, and marking information of the two content segments marked by the object is simultaneously cleared.

In addition, when there is no content marked by the object, after the switch control is turned off, the bottom search sub-interface is hidden, for example, the search sub-interface is not presented.

In the foregoing implementation, when the object may perform a search, the intelligent marking search function may be directly enabled through the switch control, thereby providing a more efficient search experience for the object. When the object does not may perform a search, the intelligent marking search function may be directly disabled through the switch control, without preventing the object from browsing in the content detail interface subsequently.

The information search method in some embodiments may be described from the client side. The information search method in some embodiments is further described below from the server side.

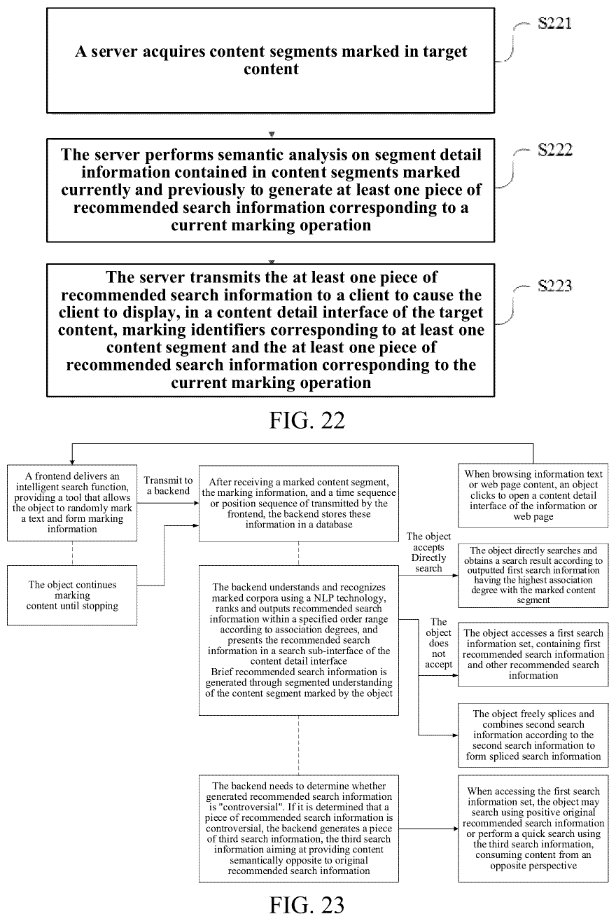

FIG. 22 is an implementation flowchart of an information search method according to some embodiments. Using a server being an execution subject as an example, a implementation procedure of the method is shown as the following S221 to S223.

S221: The server acquires content segments marked in target content.

S222: The server performs semantic analysis on segment detail information contained in content segments marked currently and previously to generate at least one piece of recommended search information corresponding to the current marking operation.

The content segments are determined by a client in response to a marking operation triggered for the target content, and each marking operation correspondingly marks at least one content segment. Details may refer to the foregoing embodiment and are not described herein again.

In some embodiments, when the object browses target content such as an information text or a web page, the client provides a tool to support the object to randomly mark a content segment in the target content and form a serial number (i.e., the marking sequence number herein). The client may acquire texts, serial numbers, and a time sequence of the marks, and then transmits the information to the server. Therefore, when acquiring the content segments from the client, the server may further receive information, such as the marking information and time sequence, corresponding to the content segments transmitted by the client.

Specifically, the client first provides an intelligent marking search function, for example, provides a tool by which the object may randomly mark a content segment (for example, a text) in a content detail interface and form a marking identifier. The client transmits information such as the content segment marked by the object, a corresponding marking identifier, and a time sequence to the server. After receiving the information such as the marked content segment, the corresponding marking identifier, and the time sequence transmitted by the client, the server performs semantic analysis on the content segments that are marked currently and previously and transmitted by the client, and generates at least one piece of recommended search information according to a semantic analysis result.

Specifically, semantic analysis is performed on segment detail information contained in the content segment, for example, the content segment is understood and integrated, including analyzing topics, keywords, association degrees, and the like of the marked content segment. In this process, the NLP technology may be adopted, including, but not limited to, word meaning understanding, entity recognition, keyword extraction, topic modeling, and the like, and is configured for understanding the topics, keywords, and the like of the marked content segment. Meanwhile, a machine learning technology such as cluster analysis may further be involved. The machine learning technology is configured for integrating similar marked content segments to extract keywords and phrases after identifying a key concept and topic, thereby generating at least one piece of recommended search information corresponding to the content segments. The following briefly describes the several NLP technologies.

Word meaning understanding: if a received content segment is a large block of text, the large block of text is first divided into a text unit sequence, for example, divided into several words, and a part of speech is assigned to each word. This process may be implemented through a machine learning method. Then, the meaning of each word may be understood through models such as word embedding, which may be implemented through a word embedding model (such as Word2Vec or GloVe). The word embedding model may convert each word into a vector, and the vector may characterize semantic information of the word.

Based on understanding the word meanings of the words in the content segment based on the foregoing manner, words may be selected from the content segment to construct recommended search information.

Entity recognition: then, based on acquiring semantics of the words in the marked content segment through the foregoing word meaning understanding, entities, such as person names, place names, or institution names, in the content segment may be further recognized through a named entity recognition (NER) technology. In some embodiments, the content segments listed in FIG. 3 to FIG. 15 contain entities such as a person name (for example, director B) and a movie name (for example, Movie C).

Keyword extraction: next, the importance of any word in the content segment to the content segment may be evaluated using a term frequency-inverse document frequency (TF-IDF) algorithm or a text rank (TextRank) algorithm. The more important a word is to the content segment, the greater the probability that the word is a keyword. The importance of the word is positively correlated to the number of occurrence times of the word in the content segment. The keyword in the content segment is extracted according to the foregoing algorithm.

Topic modeling: finally, a topic in the content segment may be found through a topic modeling technology, such as latent Dirichlet allocation (LDA).

Based on the extracted keyword, the recognized entity, the topic, and the like in the foregoing operations, at least one piece of recommended search information of the content segments may be generated, then correlations between the recommended search information and the content segments are calculated using a measurement manner such as cosine similarity, and the recommended search information is ranked in descending order of correlations.

The foregoing NLP technology procedure may be adjusted according to an actual content segment. If a processing effect of an operation is poor, another technology or algorithm may be selected to perform supplementary processing.

S223: The server transmits the at least one piece of recommended search information to the client to cause the client to display, in a content detail interface of the target content, marking identifiers corresponding to the at least one content segment and the at least one piece of recommended search information corresponding to the current marking operation.

An example in which the server feeds back only one piece of recommended search information to the client after the object performs marking each time is used. Deep understanding and association analysis may be performed on content of the marked content segment, related content is retrieved based on a database (all resources except this content) with reference to all texts, and a query with the strongest association degree (i.e., the highest semantic matching degree) and the largest number of possible search results is predicted as recommended search information. Further, the server feeds back the recommended search information to the client so that the client presents at least one piece of recommended search information in S22. Generally, a more source of the inputted content indicates that a search result is more biased to the source of the inputted content.

A presentation manner of the client side may refer to the foregoing embodiment, and details are not described herein again.

In some embodiments, the at least one piece of recommended search information may be displayed in the search sub-interface in the content detail interface, for example, displayed in the search box in the search sub-interface.

The search box cannot be manually inputted with text, but only supports presentation of at least one query ranked top comprehensively. When a query matches an object, the object may directly search through the query. Compared with an input-based search in the past, the object does not may memorize, convert, and summarize when browsing content, and directly searches by predicting an intention of the object using marked content in combination with machine learning.

In some embodiments, the content detail interface further includes an option viewing control, as shown in S111 in FIG. 11. After triggering the option viewing control, the object may view recommended search information corresponding to this marking, such as the at least one piece of recommended search information obtained above, and candidate search information except the at least one piece of recommended search information, generated by performing semantic analysis by the server on segment detail information contained in content segments marked currently and previously.

In addition to transmitting the at least one piece of recommended search information obtained above to the client, the server may further transmit the candidate search information to the client to cause the client to display, in response to a viewing operation triggered based on the option viewing control, first search information sets corresponding to the marked content segments in the content detail interface.

First search information in each first search information set includes at least one piece of recommended search information generated based on content segments marked currently and previously and candidate search information. Association degrees between the at least one piece of recommended search information and the content segments satisfy a preset association condition. For example, the ranking of the association degrees between the at least one piece of recommended search information and the content segments is within a specified sequence range. However, association degrees between the candidate search information and the content segments do not satisfy the preset association condition. For example, the ranking of the association degrees between the candidate search information and the content segments does not fall within the specified sequence range.

Specifically, the server performs semantic analysis on segment detail information contained in the content segments marked currently and previously based on the content segments, corresponding marking identifiers, time sequences, and the like transmitted by the client, to determine core viewpoints and association degrees of the content segments. After performing information recognition and sorting on the core viewpoint and association degree information, the server generates a plurality of pieces of search information with search results, ranks the search information in descending order of association degrees in combination with the association degrees between the search information and the content segments marked by the object, and transmits at least one piece of search information within the specified sequence range to the client as the foregoing at least one piece of recommended search information mainly recommended to the object. The client presents the at least one piece of recommended search information in the search sub-interface of the content detail interface. Meanwhile, the server further may transmit other search information (i.e., candidate search information) to the client. The client presents the at least one piece of recommended search information and the candidate search information in the first search information set, and the object may view the first search information set after triggering the option viewing control in the content detail interface.

For example, after the object marks a content segment 1, the server may generate a plurality of pieces of search information based on the content segment 1, rank the search information according to association degrees between the plurality of pieces of search information and the content segment 1, and feed back the search information to the client. The client may select at least one piece of search information based on a ranking result, directly display the at least one piece of search information in the content detail interface, and then display the remaining search information (i.e., the candidate search information) in the first search information set viewed by the object. When the search information is ranked within the specified sequence range such as TOP1, for example, search information with the strongest association degree with the content segment 1 may be used as recommended search information directly presented in the content detail interface, and the remaining search information that is ranked lower is further presented when the object views the first search information set.

Similarly, after the object marks a content segment 2, the server may generate a plurality of pieces of search information based on the content segment 1 and the content segment 2, rank the search information according to association degrees between the plurality of pieces of search information and the content segment 1 and association degrees between the plurality of pieces of search information and the content segment 2, and feed back the search information to the client. The client may select at least one piece of search information based on a ranking result, directly present the at least one piece of search information in the content detail interface, and then present the remaining search information (i.e., the candidate search information) in the first search information set viewed by the object.

A similar principle is adopted when the object marks other content segments, and the rest may be deduced by analogy. Details are not described herein again.

In some embodiments, when the marked content segments are clustered and ranked based on the association degrees, content segments marked each time are considered as nodes, and clustering is performed based on association degrees between all marked content segments. Content segments having strong association degrees are divided into a group, and content segments having weak association degrees are divided into another group. In addition, clustering results of the content segments are ranked based on the search requirement of the object so that the object may more easily find interested content, thereby improving correlation of the search results and the search satisfaction of the object.

For example, after the object marks content segments A, B, C, and D, the content segment D is a content segment marked by the object currently. The content segments A, B, and C having strong association degrees are divided into a group, and keywords and the like extracted from the three content segments A, B, and C are combined to generate search information 1. The content segments A and D having a weak association degree are divided into a group, and keywords and the like extracted from the two content segments A and D are combined to generate search information 2. When the search information 1 and the search information 2 are presented in the first search information set, based on the search requirement of the object, the search information 1 is ranked in front of the search information 2 so that the object may find required content more quickly.

In some embodiments, an association degree between search information and the content segment includes at least one of the following:
a semantic association degree between the search information and the content segment; and
a temporal association degree between the search information and a marking time of the content segment.

A time sequence of marking the content segments by the object may reflect a search intention of the object.

In some embodiments, when the foregoing two types of association degrees are contained, an association degree between search information and a content segment may be a result of a weighted sum of the semantic association degree and the temporal association degree.

The semantic association degree between the search information and the content segment may be calculated in the foregoing measurement manner such as the cosine similarity. When the server obtains through calculation that the association degree between the content segment marked by the object and at least one piece of corresponding search information is within the specified sequence range, the search information may be, for example, search information having the highest association degree, or search information having the highest association degree and the second highest association degree. It may be determined that the at least one piece of search information is recommended search information. Then, the at least one piece of search information is transmitted to the client and presented in the search sub-interface of the content detail interface.

The temporal association degree between the search information and the marking time of the content segment is determined according to a marking behavior of the object on the content segment. For example, if a time (a timestamp) at which the object marks a content segment is closer to a search operation of the object, search information generated by the server according to the content segment has higher importance. Therefore, when the association degrees of the search information are ranked, search information corresponding to a content segment that is recently marked by the object is endowed with a higher weight.

In some embodiments, the object may freely mark an interested or doubtful content segment in existing content and does not may convert the content segment into a keyword for searching. Instead, the system generates a first search information set based on the marked content segment. The object selects at least one piece of search information in the first search information set. Further, the server generates a search result based on the at least one piece of search information, thereby shortening the search path and improving the search efficiency.

If the object does not find search information satisfying the search requirement of the object in the first search information set, the server performs, for content segments currently marked in the target content, semantic analysis on the segment detail information contained in the content segments to generate at least one piece of second search information corresponding to the content segments. Generated second search information is transmitted to the client to cause the client to display, in response to the viewing operation triggered based on the option viewing control, the at least one piece of second search information corresponding to the marked content segments in the content detail interface. The object may automatically splice the second search information in the content detail interface to generate spliced search information.

The server generates the at least one piece of corresponding second search information according to the content segments and generates the search result according to the splicing operation of the object, which includes the following operations:

Process content marked by the object: semantic analysis and entity recognition are performed on segment detail information contained in the content segment marked by the object using a pre-trained language model through text processing and NLP technologies.

Generate the second search information: for example, a keyword in the content segment marked by the object may be extracted using an algorithm such as TF-IDF, to generate the second search information. Then, the extracted second search information may be stored in a database for subsequent use.

Different from the foregoing first search information, the second search information is generated only according to the content segment marked currently, without considering other content segments marked previously. For example, the object marks a content segment 1 “director B”, and corresponding second search information “director B” is generated. The object marks a content segment 2 “Movie C”, and corresponding second search information “Movie C” is generated. The object marks a content segment 3 “director F”, and corresponding second search information “director F” is generated, etc.

Select the second search information: the object selects required second search information in the content detail interface.

Splice the second search information: the object splices the selected second search information according to an order and combination manner of search requirements of the object. This operation relates to a client development technology. For example, the second search information is spliced using JavaScript.

Generate spliced search information: finally, the system converts the spliced second search information into the spliced search information. This operation relates to a server development technology. For example, the spliced search information is generated using Python, Java, Node.js, or the like.

In some embodiments, the object flexibly combines and ranks the second search information to provide a more personalized search experience to the object, thereby helping the object explore interested content more deeply.

In some embodiments, the server performs calculation based on the NLP model and the search result. After the recommended search information has content semantically opposite to the search result corresponding to the recommended search information, a button of reverse search prompt information is activated. When the object accepts the content of the recommended search information, a search may be directly performed. When the object does not accept or wants to see an opposite opinion, a related opposite search result in a content pool may be directly and rapidly obtained.

Specifically, controversial recommended search information in at least one piece of recommended search information is determined. For each piece of recommended search information of the at least one piece of recommended search information, third search information opposite to a viewpoint of a search result corresponding to the recommended search information is generated.

Generated third search information is transmitted to the client to cause the client to display, in response to a reverse search operation triggered based on reverse search prompt information, the third search information associated with the at least one piece of recommended search information in the content detail interface.

The reverse search prompt information is configured for prompting a search for content opposite to the viewpoint of the search result corresponding to the at least one piece of recommended search information.

Whether the recommended search information is controversial is determined in at least one of the following manners.

First analysis manner: Perform authenticity verification on the search result corresponding to the recommended search information to determine whether the recommended search information is controversial. A analysis process may refer to the foregoing embodiment, and details are not described herein again.

Second analysis manner: Perform opposite viewpoint recognition on the search result corresponding to the recommended search information through a text classification technology; and determine, according to a recognition result, whether the recommended search information is controversial. A analysis process may refer to the foregoing embodiment, and details are not described herein again.

In some embodiments, the server may generate the third search information through the following operations.

Understand original recommended search information: the meaning and intention of the original recommended search information are first understood through the NLP technology, for example, semantic analysis is performed using a pre-trained language model.

Recognize controversy: controversy of the search result corresponding to the recommended search information is first recognized through search engine query and database query, and then different viewpoints or positions in the search result are recognized using a text classification technology. If the search result corresponding to a piece of recommended search information has a plurality of opinions or positions, and proportions of the plurality of viewpoints or positions are similar, it may be considered that the recommended search information is controversial.

Generate third search information: for controversial recommended search information, third search information having opposite semantics may be generated through methods such as modifying a keyword in the original recommended search information, using an antonym, and adding a negative word. For example, for recommended search information “impact of global warming”, third search information “benefit of global warming” having opposite semantics may be generated.

Verify the third search information: finally, the server may verify whether the generated third search information is valid, which may be implemented by inputting the third search information into a search engine or a database, and then checking whether a corresponding search result is semantically opposite to a search result corresponding to the original recommended search information.

By generating the third search information, this application may better satisfy the forward and reverse search requirements of the object, which may not only improve the search efficiency, but also help the object to discover and acquire more related information, thereby improving the search experience of the object.

FIG. 23 is a schematic diagram of generation logic of recommended search information according to some embodiments.

When browsing target content such as an information text or a web page, an object clicks to open a content detail interface of the information or web page.

In this case, a client may enable an intelligent marking search function, for example, provide a tool that allows the object to randomly mark a text and form a marking identifier, and the object may continuously mark content segments.

The client may transmit, in response to a marking operation triggered by the object, a content segment marked by the object, a marking identifier, and a marking time sequence to a server. After receiving the marked content segment, marking information, and time sequence transmitted by the client, the server stores the information in a database.

Then, the server understands and recognizes the marked content segments using the NLP technology, ranks and outputs recommended search information within a specified sequence range according to association degrees, and controls the client to present the recommended search information in a search sub-interface in the content detail interface. Brief recommended search information is generated through segmented understanding of the content segment marked by the object.

If the object accepts the recommended search information, a search result may be obtained by searching directly according to the generated recommended search information having the highest association degree with the marked content segment.

If the object does not accept the recommended search information, the object may access a first search information set, which contains the foregoing recommended search information and other candidate search information (i.e., search information having a relatively low association degree with the content segment marked by the object). In some embodiments, the object freely splices and combines the second search information according to the second search information to form spliced search information. The object clicks the candidate search information or the second search information in the first search information set and controls the server to retrieve a corresponding search result.

Meanwhile, the server may further determine whether the generated recommended search information is “controversial”. If it is determined that a piece of recommended search information is controversial, the server generates a piece of associated third search information, the third search information aiming at providing content semantically opposite to original recommended search information.

In addition, when accessing the first search information set, the object may search using positive original search information or perform a quick search using the third search information, consuming content from an opposite perspective.

The schematic diagram of execution logic of the information search method listed in FIG. 23 is only a simple example. In addition, execution logic of other related information search methods is also applicable to some embodiments. Details are not described herein again.

In summary, in some embodiments, a method involving marking a plurality of content segments, predicting object search tendencies, personalized ranking, and search suggestions is provided. The system may flexibly combine and rank the search results through association degree analysis and object search tendencies according to the content segments marked by the object, thereby providing a more personalized search experience. In addition, compared with a previous long-procedure search, the present disclosure provides the object with a capability of searching through a plurality of pieces of marked content, shortening the search path. The system may generate richer search suggestions and related content recommendation, help the object explore the interested topic more deeply, and provide a more accurate and personalized search experience for the object, thereby improving the object's satisfaction and reputation.

Information such as articles and news on the current market contains very abundant content, many and complex described events, and many related characters/positions. It is very difficult for the system to determine the interested content of the object, and the recommendations derived from this are actually not accurate. The marking function provided in this application is not limited to a structure form of marked content. Regardless of the content structure, the system may output the query from two aspects, i.e., “understanding, integrating, and calculating association degrees” and “retrieving other related information having the highest matching degree with the query in the whole network”, based on marked original content, regardless of whether it is strongly or weakly related to the original main content (although the marked texts all come from the original text, they may be non-main events). Similar to prompt (a language model-based generative model) generated through artificial intelligence, the object may find the most interested extended content using the query so that the object rapidly selects an ideal search result. The object obtains a very convenient search capability with lowest input costs (marking) and searches for other related content through customized content. Currently, in a mainstream search manner, even if the object inputs a long text, original content is still outputted. This innovative solution helps to improve object stickiness and create higher commercial values in a content-embedded content manner.

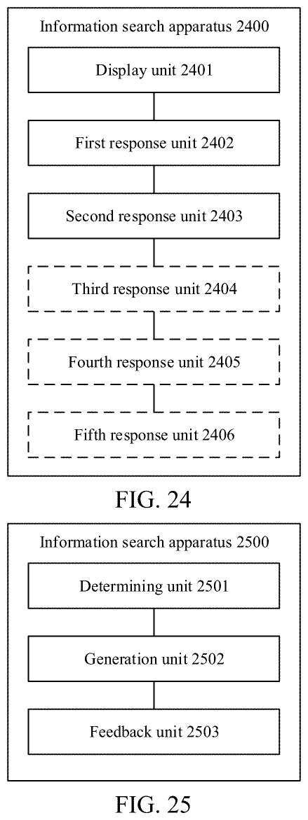

Based on the same inventive concept, some embodiments further provide an information search apparatus. FIG. 24 is a schematic structural diagram of an information search apparatus 2400, which may include:
a display unit 2401 configured to display a content detail interface of target content;
a first response unit 2402 configured to display, in response to a marking operation triggered for at least one content segment in the target content, marking identifiers corresponding to the at least one content segment and at least one piece of recommended search information corresponding to the current marking operation in the content detail interface, the recommended search information being generated based on segment detail information contained in content segments marked by the current marking operation and previous marking operations; and
a second response unit 2403 configured to display, in response to a search operation triggered based on target recommended search information in the at least one piece of recommended search information, a search result corresponding to the target recommended search information.

In some embodiments, the first response unit 2402 is configured to:
display, in response to the marking operation triggered for the at least one content segment, the at least one piece of recommended search information corresponding to the current marking operation in a search sub-interface of the content detail interface.

In some embodiments, the content detail interface further includes a switch control configured for intelligent search control. The first response unit 2402 is further configured to: before displaying, in response to the marking operation triggered for the at least one content segment in the target content, the marking identifiers corresponding to the at least one content segment and the at least one piece of recommended search information corresponding to the current marking operation in the content detail interface,
display, in response to an enabling operation triggered based on the switch control, the search sub-interface in the content detail interface.

In addition, the first response unit 2402 is configured to:
display the at least one piece of recommended search information corresponding to the current marking operation in the search sub-interface.

In some embodiments, the first response unit 2402 is further configured to:
cancel, in response to a disabling operation triggered based on the switch control, display of the search sub-interface, and clear the marking identifiers that are displayed in the content detail interface and correspond to the content segments marked by the marking operation.

In some embodiments, the content detail interface further includes an option viewing control. The apparatus further includes:
a third response unit 2404 configured to display, in response to a viewing operation triggered based on the option viewing control, first search information sets corresponding to the content segments marked by the marking operation in the content detail interface.

First search information in the first search information set includes the at least one piece of recommended search information generated based on the content segments marked by the current marking operation and the previous marking operations and candidate search information, association degrees between the at least one piece of recommended search information and the content segments satisfy a preset association condition, and association degrees between the candidate search information and the content segments do not satisfy the preset association condition.

In some embodiments, the third response unit 2404 is further configured to:
display, in response to a search operation triggered based on any piece of first search information, a search result corresponding to the any piece of first search information.

In some embodiments, the third response unit 2404 is further configured to:
display, in the content detail interface, at least one piece of second search information corresponding to the content segments marked by the marking operation, the second search information being recommended search information generated based on the content segments marked by the current marking operation.

In some embodiments, the third response unit 2404 is further configured to:
display, in response to a search operation triggered based on the at least one piece of second search information, a search result corresponding to spliced search information, the spliced search information being obtained by splicing the at least one piece of second search information.

In some embodiments, the apparatus further includes:
a fourth response unit 2405 configured to display reverse search prompt
information in the content detail interface, the reverse search prompt information being configured for prompting a search for content that is semantically opposite to a search result corresponding to the at least one piece of recommended search information; and display, in response to a reverse search operation triggered based on the reverse search prompt information, third search information associated with the at least one piece of recommended search information in the content detail interface, content of a search result corresponding to the third search information being semantically opposite to content of a search result corresponding to associated recommended search information.

In some embodiments, the fourth response unit 2405 is configured to:
display, in response to the reverse search operation triggered based on the reverse search prompt information, the third search information associated with the at least one piece of recommended search information and third search information associated with the candidate search information in the search sub-interface of the content detail interface.

The candidate search information is generated based on the content segments marked by the current marking operation and the previous marking operations, and the association degrees between the candidate search information and the content segments are lower than the association degrees between the recommended search information and the content segments.

In some embodiments, the fourth response unit 2405 is further configured to:
display, in response to a search operation triggered based on any piece of third
search information, a search result corresponding to the any piece of third search information.

In some embodiments, before presenting the reverse search prompt information in the content detail interface, the fourth response unit 2405 is further configured to:
determine controversial recommended search information among the at least one piece of recommended search information currently presented in the content detail interface.

In some embodiments, the fourth response unit 2405 is further configured to determine whether the recommended search information is controversial in at least one of the following manners:
performing authenticity verification on the search result corresponding to the recommended search information to determine whether the recommended search information is controversial; and
performing opposite viewpoint recognition on the search result corresponding to the recommended search information; and determining, according to a recognition result, whether the recommended search information is controversial.

In some embodiments, the apparatus further includes:
a fifth response unit 2406 configured to update, in response to an unmarking operation triggered for the at least one content segment, displayed recommended search information in the content detail interface, updated recommended search information being generated based on the content segments currently marked by the marking operation in the target content.

Based on the same inventive concept, some embodiments further provide another information search apparatus. FIG. 25 is a schematic structural diagram of an information search apparatus 2500, which may include:
a determining unit 2501 configured to acquire content segments marked in target content, the content segments being determined by a client in response to a marking operation triggered for the target content, and each marking operation correspondingly marking at least one content segment;
a generation unit 2502 configured to perform semantic analysis on segment detail information contained in content segments marked currently and previously to generate at least one piece of recommended search information corresponding to the current marking operation; and
a feedback unit 2503 configured to transmit the at least one piece of recommended search information to the client to cause the client to display, in a content detail interface of the target content, marking identifiers corresponding to the at least one content segment and the at least one piece of recommended search information corresponding to the current marking operation.

In some embodiments, the content detail interface further includes an option viewing control. The generation unit 2502 is further configured to:
perform semantic analysis on the segment detail information contained in the content segments marked currently and previously to generate candidate search information corresponding to the current marking operation.

In addition, the feedback unit 2503 is further configured to:
transmit the candidate search information to the client to cause the client to display, in response to a viewing operation triggered based on the option viewing control, first search information sets corresponding to marked content segments in the content detail interface.

First search information in each first search information set includes the at least one piece of recommended search information generated based on the content segments marked currently and previously and the candidate search information, association degrees between the at least one piece of recommended search information and the content segments satisfy a preset association condition, and association degrees between the candidate search information and the content segments do not satisfy the preset association condition.

In some embodiments, an association degree between search information and the content segment includes at least one of the following, the search information including the recommended search information and the candidate search information:
a semantic association degree between the search information and the content segment; and
a temporal association degree between the search information and a marking time of the content segment.

In some embodiments, the content detail interface further includes an option viewing control. The generation unit 2502 is further configured to:
perform, for marked content segments in the target content, semantic analysis on the segment detail information contained in the content segments to generate at least one piece of second search information corresponding to the content segments.

The feedback unit 2503 is further configured to:
transmit generated second search information to the client to cause the client to display, in response to the viewing operation triggered based on the option viewing control, the at least one piece of second search information corresponding to the content segments marked by the marking operation in the target content in the content detail interface.

In some embodiments, the generation unit 2502 is further configured to:
generate, for each piece of recommended search information of the at least one piece of recommended search information, third search information opposite to a viewpoint of a search result corresponding to the recommended search information.

The feedback unit 2503 is further configured to:
transmit generated third search information to the client to cause the client to display, in response to a reverse search operation triggered based on reverse search prompt information, the third search information associated with the at least one piece of recommended search information in the content detail interface, the reverse search prompt information being configured for prompting a search for content opposite to the viewpoint of the search result corresponding to the at least one piece of recommended search information.

In some embodiments, the generation unit 2502 is further configured to:
determine controversial recommended search information among the at least one piece of recommended search information displayed in the content detail interface; and
determine whether the recommended search information is controversial in at least one of the following manners:
performing authenticity verification on the search result corresponding to the recommended search information to determine whether the recommended search information is controversial; and
performing opposite viewpoint recognition on the search result corresponding to the recommended search information through a text classification technology; and
determining, according to a recognition result, whether the recommended search information is controversial.

Based on the foregoing implementations, in some embodiments, when browsing content details of the target content, the object may directly mark the content segments in the content detail interface. For example, the object may mark, according to its own requirement, an interested content segment, a doubtful content segment, or the like. Further, in this application, according to the marking operation of the object in a browsing process, the recommended search information may be intelligently generated by performing semantic analysis on the segment detail information contained in the content segments marked currently and previously, and presented to the object. Since the recommended search information is generated through analysis according to the content segments marked by the object, a search requirement of the object may be effectively reflected. In addition, based on this, the object may further perform an information search based on the target recommended search information in the displayed recommended search information. In the search process, the object marks the content segments only according to its own search requirement and does not may spend time thinking and manually inputting a search keyword, thereby effectively improving the search efficiency. In addition, based on better satisfying the search requirement of the object, this manner may further help the object to discover and acquire more related information, thereby improving the search experience of the object and improving the richness of information acquired by the object.

For ease of description, the above parts are divided into various modules (or units) according to their functions and described separately. Certainly, in the implementation of this application, the functions of various modules (or units) may be implemented in the same piece of or a plurality of pieces of software and/or hardware.

After the information search method and apparatus in exemplary implementations of this application are described, an electronic device according to another exemplary implementation of this application is described below.

A person skilled in the art may understand that various aspects of this application may be implemented as systems, methods, or program products. Therefore, the aspects of this application may be implemented in the following form, i.e., a complete hardware implementation, a complete software implementation (including firmware, microcode, and the like), or an implementation that combines hardware and software aspects, which may be collectively referred to herein as a “circuit”, “module”, or “system”.

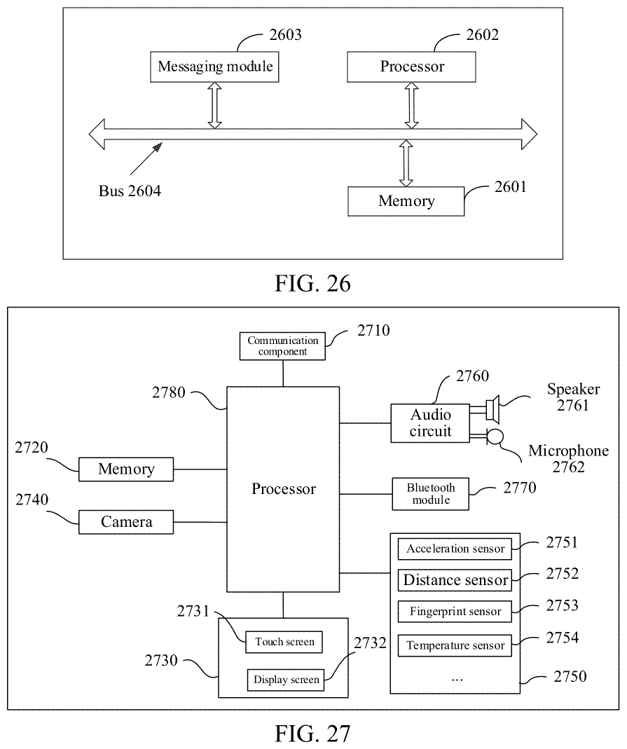

Based on the same inventive concept as the foregoing method embodiment, some embodiments further provide an electronic device. In some embodiments, the electronic device may be a server, for example, the server 120 shown in FIG. 1. In some embodiments, the structure of the electronic device may be shown in FIG. 26, including a memory 2601, a messaging module 2603, and one or more processors 2602.

The memory 2601 is configured to store a computer program executed by the processor 2602. The memory 2601 may mainly include a program storage area and a data storage area. The program storage area may store an operating system, programs required for running instant messaging functions, and the like. The data storage area may store instant messaging information, operating instruction sets, and the like.

The memory 2601 may be a volatile memory such as a random-access memory (RAM); or may be a non-volatile memory such as a read-only memory, a flash memory, a hard disk drive (HDD), or a solid-state drive (SSD); or may be any other medium capable of carrying or storing a desired computer program in the form of instructions or data structures and capable of being accessed by a computer, but is not limited thereto. The memory 2601 may be a combination of the foregoing memories.

The processor 2602 may include one or more central processing units (CPUs), a digital processing unit, or the like. The processor 2602 is configured to implement the foregoing recommended search information generation method when invoking the computer program stored in the memory 2601.

The messaging module 2603 is configured to communicate with a terminal device and other servers.

A connection medium among the foregoing memory 2601, messaging module 2603, and processor 2602 is not limited in some embodiments. In some embodiments, the memory 2601 and the processor 2602 are connected through a bus 2604 in FIG. 26. The bus 2604 is described through a thick line in FIG. 26. A connection manner among other assemblies is merely for exemplary description and is not intended to be limiting. The bus 2604 may be classified as an address bus, a data bus, a control bus, or the like. For ease of description, only one thick line is used for description in FIG. 26, but this does not imply that there is only one bus or one type of bus.

The memory 2601 has a computer storage medium stored therein, and the computer storage medium has computer-executable instructions stored therein for implementing the information search method of some embodiments. The processor 2602 is configured to perform the foregoing information search method, as shown in FIG. 2.

In some embodiments, the electronic device may be another electronic device, such as the terminal device 110 shown in FIG. 1. In some embodiments, the electronic device has a structure shown in FIG. 27, and includes: a communication component 2710, a memory 2720, a display unit 2730, a camera 2740, a sensor 2750, an audio-frequency circuit 2760, a Bluetooth module 2770, a processor 2780, and another component.

The communication component 2710 is configured to communicate with a server. In some embodiments, a circuit wireless fidelity (WiFi) module may be included. The WiFi module belongs to a short-distance wireless transmission technology. The electronic device may help the user to receive and transmit information through the WiFi module.

The memory 2720 may be configured to store software programs and data. The processor 2780 executes various functions of the terminal device 110 and data processing by running software programs or data stored in the memory 2720. In addition, the memory 2720 may include a high-speed RAM and a non-volatile memory, such as at least one magnetic disk storage device, a flash memory device, or other volatile solid-state storage devices. The memory 2720 stores an operating system that enables the terminal device 110 to run. In this application, the memory 2720 may store an operating system and various application programs and may further store a computer program for performing the information search method in some embodiments.

The display unit 2730 may further be configured to display information inputted by the user, information provided to the user, and a graphical user interface (GUI) of various menus of the terminal device 110. Specifically, the display unit 2730 may include a display screen 2732 arranged on a front surface of the terminal device 110. The display screen 2732 may be configured through a liquid crystal display, a light-emitting diode, or the like. The display unit 2730 may be configured to display the content detail interface, search sub-interface, and the like in some embodiments.

The display unit 2730 may further be configured to receive inputted numeric or character information and generate a signal input related to user settings and function control of the terminal device 110. Specifically, the display unit 2730 may include a touch screen 2731 provided on the front surface of the terminal device 110, which may acquire touch operations of the object on or near the touch screen 2731, such as clicking a button and dragging a scroll box.

The touch screen 2731 may cover the display screen 2732, or the touch screen 2731 and the display screen 2732 may be integrated to implement input and output functions of the terminal device 110. The integrated screen may be referred to as a touch display screen. In this application, the display unit 2730 may display an application program and corresponding operations.

The camera 2740 may be configured to capture a static image, and the user may publish an image captured by the camera 2740 through an application. There may be one or more cameras 2740. An object generates an optical image through a lens, and the optical image is projected to a photosensitive element. The photosensitive element may be a charge coupled device (CCD) or a complementary metal-oxide-semiconductor (CMOS) phototransistor. The photosensitive element converts an optical signal into an electric signal, and then transfers the electric signal to the processor 2780 to convert into a digital image signal.

The terminal device may further include at least one sensor 2750, such as an acceleration sensor 2751, a distance sensor 2752, a fingerprint sensor 2753, and a temperature sensor 2754. The terminal device may further be configured with other sensors such as a gyroscope, a barometer, a hygrometer, a thermometer, an infrared sensor, an optical sensor, and a motion sensor.

The audio circuit 2760, a speaker 2761, and a microphone 2762 may provide audio interfaces between the user and the terminal device 110. The audio circuit 2760 may convert received audio data into an electric signal and transmit the electric signal to the speaker 2761. The speaker 2761 converts the electric signal into a sound signal and outputs the sound signal. The terminal device 110 may further be provided with a volume button configured to adjust volume of a sound signal. In addition, the microphone 2762 converts an acquired sound signal into an electric signal. The electric signal is received by the audio circuit 2760 and converted into audio data, and then audio data is outputted to the communication component 2710 to be transmitted to another terminal device 110, or the audio data is outputted to the memory 2720 for further processing.

The Bluetooth module 2770 is configured to perform, through a Bluetooth protocol, information interaction with another Bluetooth device having a Bluetooth module. For example, the terminal device may establish, through the Bluetooth module 2770, a Bluetooth connection with a wearable electronic device (such as, a smart watch) also having a Bluetooth module, to perform data interaction.

The processor 2780 is a control center of the terminal device and is connected to various parts of the entire terminal using various interfaces and lines. The processor 2780 executes various functions of the terminal device and performs data processing by running or executing a software program stored in the memory 2720 and invoking data stored in the memory 2720. In some embodiments, the processor 2780 may include one or more processing units. An application processor and a baseband processor may be integrated into the processor 2780. The application processor mainly processes the operating system, a user interface, an application program, and the like, and the baseband processor mainly processes wireless communication. The foregoing baseband processor may either not be integrated into the processor 2780. In this application, the processor 2780 may run an operating system, an application program, a user interface display, a touch response, and the information search method in some embodiments. In addition, the processor 2780 is coupled to the display unit 2730.

In some possible implementations, various aspects of the information search method provided in this application may be implemented in the form of a program product including a computer program. When the program product runs on an electronic device, the computer program is configured to enable the electronic device to perform the operations in the information search method described in this specification according to various exemplary implementations of this application. For example, the electronic device may perform the operations shown in FIG. 2 or FIG. 22.

The program product may be any combination of one or more readable mediums. The readable medium may be a readable signal medium or a readable storage medium. For example, the readable storage medium may be, but is not limited to, an electric, magnetic, optical, electromagnetic, infrared, or semi-conductive system, apparatus, or device, or any combination thereof. More examples (a non-exhaustive list) of the readable storage medium include: an electrical connection having one or more wires, a portable disk, a hard disk, a RAM, a ROM, an erasable programmable ROM (EPROM or a flash memory), an optical fiber, a compact disc ROM (CD-ROM), an optical storage device, a magnetic storage device, or any appropriate combination thereof.

The program product of some embodiments may adopt a portable CD-ROM and include a computer program, and may be run on the electronic device. However, the program product in this application is not limited thereto. In this specification, the readable storage medium may be any tangible medium containing or storing a program, and the program may be used by or used in combination with an instruction execution system, an apparatus, or a device.

The readable signal medium may include a data signal being in a baseband or propagated as a part of a carrier, in which a readable computer program is carried. A data signal propagated in such a way may adopt a plurality of forms, including, but not limited to, an electromagnetic signal, an optical signal, or any appropriate combination thereof. The readable signal medium may be any readable medium except the readable storage medium, and the readable medium may transmit, propagate, or transport a program used by or in combination with an instruction execution system, apparatus, or device.

The computer program included in the readable medium may be transmitted through any suitable medium, including but not limited to a wireless medium, a wire medium, an optical cable, a radio frequency (RF), etc., or any appropriate combination thereof.

The computer program for performing the operations of this application may be written through one or more programming languages or a combination thereof. The programming languages include an object-oriented programming language, such as Java and C++, and further include a procedural programming language, such as “C” or similar programming languages. The computer program may be completely executed on a user electronic device, partially executed on a user electronic device, executed as an independent software package, partially executed on a user electronic device and partially executed on a remote electronic device, or completely executed on a remote electronic device or server. In a case involving the remote electronic device, the remote electronic device may be connected to the user electronic device through any type of network including a local area network (LAN) or a wide area network (WAN), or may be connected to an external electronic device (for example, through the Internet using an Internet service provider).

Although several units or sub-units of the apparatus have been mentioned in the detailed description above, such division is merely exemplary and not mandatory. Actually, according to some embodiments, the features and functions of two or more units described above may be implemented in one unit. On the contrary, the features and functions of one unit described above may be further divided to be implemented by a plurality of units.

In addition, although the operations of the method in this application are described in a order in the accompanying drawings, this does not require or imply that these operations are to be performed in the order, or all operations shown are to be performed to achieve the expected result. In some embodiments, some operations may be omitted, a plurality of operations may be combined into one operation for execution, and/or one operation may be decomposed into a plurality of operations for execution.

A person skilled in the art is to understand that some embodiments may be provided as a method, a system, or a computer program product. Therefore, this application may use the forms of hardware-only embodiments, software-only embodiments, or embodiments combining software and hardware. Moreover, this application may use a form of a computer program product that is implemented on one or more computer-usable storage media (including but not limited to a disk memory, a CD-ROM, an optical memory, and the like) that contain a computer-usable computer program.

This application is described with reference to flowcharts and/or block diagrams of the method, the device (system), and the computer program product according to some embodiments. Computer program instructions may implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine so that an apparatus configured to implement functions specified in one or more procedures in the flowcharts and/or one or more blocks in the block diagrams is generated through instructions executed by the computer or the processor of another programmable data processing device.

These computer program instructions may be stored in a computer-readable memory that can instruct a computer or another programmable data processing device to work in a manner so that the instructions stored in the computer-readable memory generate an artifact that includes an instruction apparatus. The instruction apparatus implements functions specified in one or more procedures in the flowcharts and/or one or more blocks in the block diagrams.

These computer program instructions may further be loaded onto a computer or another programmable data processing device so that a series of operations are performed on the computer or the another programmable device, thereby generating computer-implemented processing. Therefore, the instructions executed on the computer or the another programmable device provide operations for implementing functions specified in one or more procedures in the flowcharts and/or one or more blocks in the block diagrams.

Although exemplary embodiments of this application have been described, once a person skilled in the art knows the basic creative concept, additional changes and modifications may be made to these embodiments. Therefore, the following claims are intended to be construed as to include the exemplary embodiments and all changes and modifications falling within the scope of this application.

Obviously, a person skilled in the art may make various modifications and variations to this application without departing from the spirit and scope of this application. In this case, if the modifications and variations made to this application fall within the scope of the claims of this application and their equivalent technologies, this application is intended to contain these modifications and variations.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An information search method, performed by an electronic device, and comprising:
displaying a content detail interface of target content;
receiving a marking operation selecting at least one content segment within the target content;
displaying, based on the marking operation, marking identifiers corresponding to the at least one content segment;
generating and displaying at least one piece of recommended search information based on segment detail information in content segments marked by the marking operation and at least one previous marking operation; and
receiving a search operation selecting target recommended search information from the at least one piece of recommended search information;
displaying a search result corresponding to the target recommended search information.

2. The method according to claim 1, wherein the generating and displaying at least one piece of recommended search information comprises:
displaying the at least one piece of recommended search information corresponding to the current marking operation in a search sub-interface of the content detail interface.

3. The method according to claim 2,
wherein the content detail interface further comprises a switch control for intelligent search; and
wherein the method further comprises:
receiving an enabling operation from the switch control prior to receiving the marking operation;
displaying, based on the enabling operation, the search sub-interface in the content detail interface; and
displaying the at least one piece of recommended search information in the search sub-interface.

4. The method according to claim 3, further comprising:
receiving a disabling operation from the switch control;
removing display of the search sub-interface based on the disabling operation; and
clearing marking identifiers displayed in the content detail interface corresponding to content segments marked by the marking operation.

5. The method according to claim 1, wherein the content detail interface further comprises an option viewing control; and the method further comprises:
receiving a viewing operation from the option viewing control;
displaying, based on the viewing operation, first search information sets corresponding to the content segments marked by the marking operation and the at least one previous marking operation in the content detail interface,
wherein each of the first search information sets comprises:
first search information including the at least one piece of recommended search information and candidate search information;
wherein association degrees between the at least one piece of recommended search information and the content segments satisfy a preset association condition; and
wherein association degrees between the candidate search information and the content segments do not satisfy the preset association condition.

6. The method according to claim 5, further comprising:
receiving a search operation selecting target first search information from the first search information sets;
displaying a search result corresponding to the target first search information.

7. The method according to claim 1, further comprising:
generating at least one piece of second search information based on segment detail information in content segments marked by the marking operation, wherein the at least one piece of second search information is generated independently from content segments marked by the at least one previous marking operation; and
displaying the at least one piece of second search information in the content detail interface.

8. The method according to claim 7, further comprising:
receiving a splicing operation selecting multiple pieces of second search information from the at least one piece of second search information;
generating spliced search information by combining the selected multiple pieces of second search information; and
displaying a search result corresponding to spliced search information.

9. The method according to claim 1, further comprising:
displaying reverse search prompt information in the content detail interface, wherein the reverse search prompt information indicates availability of semantically opposite search results;
receiving a reverse search operation via the reverse search prompt information;
generating third search information associated with the at least one piece of recommended search information, wherein a search result corresponding to the third search information is semantically opposite to a search result corresponding to the at least one piece of recommended search information;
displaying the third search information associated with the at least one piece of recommended search information in the content detail interface.

10. The method according to claim 9, wherein the displaying the third search information comprises:
displaying the third search information associated with the at least one piece of recommended search information in the search sub-interface of the content detail interface;
displaying additional third search information associated with candidate search information in the search sub-interface;
wherein the candidate search information is generated based on the content segments marked by the marking operation and the at least one previous marking operation, and the association degrees between the candidate search information and the content segments are lower than the association degrees between the at least one recommended search information and the content segments.

11. The method according to claim 9, further comprising:
receiving a search operation selecting target third search information from the third search information;
displaying a search result corresponding to the target third search information.

12. The method according to claim 1, further comprising:
determining controversial recommended search information among the at least one piece of recommended search information displayed in the content detail interface.

13. The method according to claim 12, wherein whether the recommended search information is controversial is determined in at least one of the following manners:
performing authenticity verification on the search result corresponding to the at least one recommended search information; or
performing opposite viewpoint recognition on the search result corresponding to the at least one recommended search information; and determining whether the recommended search information is controversial.

14. The method according to claim 1, further comprising:
receiving an unmarking operation removing at least one marked content segment from the content segments;
generating updated recommended search information based on remaining content segments after the unmarking operation;
displaying the updated recommended search information in the content detail interface.

15. An information search apparatus, comprising:
at least one memory configured to store program code; and
at least one processor configured to read the program code and operate as instructed by the program code, the program code comprising:
display code configured to cause at least one of the at least one processor to display a content detail interface of target content;
receiving code configured to cause at least one of the at least one processor to receive a marking operation selecting at least one content segment within the target content;
marking code configured to cause at least one of the at least one processor to display, based on the marking operation, marking identifiers corresponding to the at least one content segment;
recommendation code configured to cause at least one of the at least one processor to generate and display at least one piece of recommended search information based on segment detail information in content segments marked by the marking operation and at least one previous marking operation; and
search code configured to cause at least one of the at least one processor to receive a search operation selecting target recommended search information from the at least one piece of recommended search information;
result code configured to cause at least one of the at least one processor to display a search result corresponding to the target recommended search information.

16. The apparatus according to claim 15, wherein the recommendation code is further configured to cause at least one of the at least one processor to:
display the at least one piece of recommended search information corresponding to the current marking operation in a search sub-interface of the content detail interface.

17. The apparatus according to claim 16,
wherein the content detail interface further comprises a switch control for intelligent search; and
wherein the program code further comprises:
switch code configured to cause at least one of the at least one processor to receive an enabling operation from the switch control prior to receiving the marking operation;
interface code configured to cause at least one of the at least one processor to display, based on the enabling operation, the search sub-interface in the content detail interface; and
wherein the recommendation code is further configured to cause at least one of the at least one processor to display the at least one piece of recommended search information in the search sub-interface.

18. The apparatus according to claim 17, wherein the program code further comprises:
disabling code configured to cause at least one of the at least one processor to receive a disabling operation from the switch control;
removal code configured to cause at least one of the at least one processor to remove display of the search sub-interface based on the disabling operation; and
clearing code configured to cause at least one of the at least one processor to clear marking identifiers displayed in the content detail interface corresponding to content segments marked by the marking operation.

19. The apparatus according to claim 15, wherein the content detail interface further comprises an option viewing control; and wherein the program code further comprises:
viewing code configured to cause at least one of the at least one processor to receive a viewing operation from the option viewing control;
sets code configured to cause at least one of the at least one processor to display, based on the viewing operation, first search information sets corresponding to the content segments marked by the marking operation and the at least one previous marking operation in the content detail interface,
wherein each of the first search information sets comprises:
first search information including the at least one piece of recommended search information and candidate search information;
wherein association degrees between the at least one piece of recommended search information and the content segments satisfy a preset association condition; and
wherein association degrees between the candidate search information and the content segments do not satisfy the preset association condition.

20. A non-transitory computer-readable storage medium, storing computer code which, when executed by at least one processor, causes the at least one processor to at least:
display a content detail interface of target content;
receive a marking operation selecting at least one content segment within the target content;
display, based on the marking operation, marking identifiers corresponding to the at least one content segment;
generate and display at least one piece of recommended search information based on segment detail information in content segments marked by the marking operation and at least one previous marking operation; and
receive a search operation selecting target recommended search information from the at least one piece of recommended search information;
display a search result corresponding to the target recommended search information.
